(19) United States
(12) Patent Application Publication
(10) Pub. No.: US 2022/0025221 A1
(43) Pub. Date: Jan. 27, 2022

(54) LATENTLY REACTIVE ADHESIVE FILM

(71) Applicant: TESA SE, Norderstedt (DE)

(72) Inventor: Marco KUPSKY, Quickborn (DE)

(73) Assignee: TESA SE, Norderstedt (DE)

(21) Appl. No.: 17/281,751

(22) PCT Filed: Sep. 20, 2019
(86) PCT No.: PCT/EP2019/075337

§ 371 Date: Mar. 31, 2021

(30) Foreign Application Priority Data
Oct. 1, 2018 (DE) 10 2018 216 868.7

(51) Int. Cl. C09J 7/35; C09J 7/10; C09J 5/06

(52) U.S. Cl. CPC C09J 7/35; C09J 7/10; C09J 2475/00; C09J 2301/304; C09J 2463/00; C09J 5/06

(57) ABSTRACT

The invention relates to a thermally curable adhesive film comprising at least one layer of an adhesive comprising at least one epoxy-functionalized (co)polymer (A) having a weight-average molar mass in the range from 5000 g/mol to 5 000 000 g/mol and/or at least one epoxy-containing compound (B) different from the (co)polymer (A); at least one free-radical former (C); and at least one photoacid former (D). The invention further relates to a bond comprising two substrates that are bonded by the adhesive film or the adhesive of the present invention, and to a method of joining two substrates using the adhesive film or the adhesive of the present invention.

This application is a 371 of PCT/EP2019/075337, filed Sep. 20, 2019, which claims foreign priority benefit under 35 U.S.C. § 119 of German Patent Application No. 10 2018 216 868.7, filed Oct. 1, 2018, the disclosures of which are incorporated herein by reference.

The invention relates to a thermally curable adhesive film comprising at least one layer of an adhesive which comprises

at least one (co)polymer (A) functionalized with epoxide groups and having a weight-average molar mass in the range from 5 000 g/mol to 5 000 000 g/mol and/or at least one epoxide-containing compound (B) which is different from the (co)polymer (A);

at least one radical initiator (C); and

at least one photo acid generator (D). The invention further relates to an assembly comprising two substrates which are bonded by the adhesive film or the adhesive of the present invention, and also to a method for joining two substrates using the adhesive film of the present invention.

Adhesive films are a long-known means of bonding two substrates to one another in order to avoid the disadvantages of liquid adhesives. Among the advantages afforded by the said films are the capacities for convenient storage and transportation, for ease of conversion and for ease of application in the use scenario. Depending on the adhesive used for the adhesive film, it is possible for the repositioning properties to be good in spite of adhesive forces which are ultimately very high. Adhesive tapes are used nowadays in diverse forms, as auxiliaries in processes and for joining different objects, for example. Many self-adhesive tapes which comprise pressure-sensitive adhesives have a permanent tack. They are able to fulfill their joining function without further curing, typically immediately after bonding. Self-adhesive tapes of these kinds can be used to achieve in some cases very high bond strengths. In certain applications, nevertheless, there is a demand for adhesive solutions which permit even higher bond strengths than conventional self-adhesive tapes.

Many such adhesive systems which lead to high-strength bonds are applied in a hot injection step. The adhesives used—which are often not self-adhesive at room temperature—then melt, wet the bond substrate, and develop strength in the course of cooling, through solidification. Adhesive systems of this kind may also have chemical reactivity. Such reactions may be utilized in order to increase the cohesion of the adhesive and so to further optimize the bond strength. Furthermore, such reactions may have a positive effect on the chemical resistance and the weathering resistance.

Some reactive adhesives comprise a polymer composition reactive with a curing agent, and such a curing agent. The polymer in this case has functional groups which can be brought to reaction with corresponding groups of the curing agent by appropriate activation. The term “curable adhesives” is therefore used in the prior art to refer to preparations containing functional groups which, through exposure to a corresponding curing component in combination with elevated temperature as an additional stimulus, are able to participate in a reaction which leads to an increase in molar mass and/or to crosslinking of at least one constituent of the preparation and/or which covalently bonds different constituents of the preparation to one another. One possibility for this purpose is that of cationic polymerization.

It is known that a cationic polymerization may be initiated thermally by interaction of a radical initiator with a cationic photoinitiator. For example, Adv. Polym. Sci., 1997, 127, 59 gives an overview of various initiators for the activation of a cationic polymerization/curing process for epoxides and vinyl ethers. Thermally and/or photochemically activatable initiators are discussed. Cationic polymerization assisted by free radicals is also discussed, albeit with a focus on photochemical activation. The radiation times are said to be 10 min to 120 min. There is no mention of fast-curing adhesives or latent reactive adhesive tapes. Nor do the specified reaction times suggest that systems for fast curing are accessible by way of this approach.

Latent reactive adhesive tapes cured by cationic polymerization are described in WO 2016/047387 A1, for example, but the initiation is via a photo acid generator.

The disadvantage of adhesive tapes of this type which comprise a photo acid generator (PAG) is that production and processing necessarily take place in the absence of light, and the substrates and/or the adhesive to be cured must be transparent for the activation range. The PAGs are usually selected from a UV range which can also occur in the ambient light and/or react at least partly under ambient light conditions, since activation in the UVC range or even in the hard UVC range is avoided as far as possible in usage.

It was an object of the present invention, therefore, to provide latent reactive adhesive tapes on a 1-component adhesive basis that are cured by cationic polymerization yet do not require cooling on storage—that is, are stable at room temperature and preferably at 40° C. The adhesive tapes are intended, moreover, to feature typical short activation times, more particular a few minutes, and/or activation temperatures, more particularly at about 180° C. to 220° C., preferably up to 200° C., especially preferably at 180° C.

The inventor of the present invention has surprisingly found that the object can be achieved by means of an adhesive tape and/or an adhesive film which comprises an adhesive which comprises at least a mixture of at least one (co)polymer (A) functionalized with epoxide groups and having a weight-average molar mass in the range from 5 000 g/mol to 5 000 000 g/mol and/or at least one epoxide-containing compound (B) which is different from (A), at least one specific radical initiator (C) and at least one photo acid generator (D).

It has likewise surprisingly been found that the adhesive systems of the present invention, in contrast to systems which contain no specific radical initiator and comprise only photo acid generators, are suitable for a host of applications where the desired bonding is of substrates to be joined that are not UV-resistant and/or not UV-transparent. In particular, then, they can be used for black and white products and/or for products filled with fillers and/or functional fillers, such use having been hitherto impossible and yet very desirable from the standpoint of the customers.

Further advantages are an outstanding latency, which can be increased further by the additional use of dyes and/or fillers. Moreover, the activation range of the system can be tailored through the specific selection of the radical initiator, by way of its half-life. The invention relates accordingly in a first aspect to a thermally curable adhesive film comprising at least one layer of an adhesive which comprises or consists of at least one (co)polymer (A) functionalized with epoxide groups and having a weight-average molar mass in the range from 5 000 g/mol to 5 000 000 g/mol and/or at least one epoxide-containing compound (B) which is different from the (co)polymer (A);

at least one radical initiator (C);

at least one photo acid generator (D);

optionally at least one matrix polymer as film former (E); and optionally at least one additive (F).

In a second aspect the invention relates to an assembly comprising two substrates which are bonded by an adhesive film or the adhesive according to the present invention. The adhesive per se is not a subject of the present invention. The adhesive of the present invention which is used in the assembly is defined below. It is the same adhesive which is a constituent of the adhesive film. Consequently all preferred embodiments described for the adhesive of the adhesive film are also preferred for the adhesive of the substrate.

In a third aspect the invention relates to a method for joining two substrates using an adhesive film or an adhesive according to the present invention.

### BRIEF DESCRIPTION OF THE DRAWINGS

The invention will now be described in greater detail with reference to the drawings, wherein:

FIG. 1 is a graph showing the results of an epoxy resin investigated, with Comparative examples 1 to 3 and Inventive example 1.

FIG. 2 is a graph showing the results of an epoxide homopolymer investigated, with Comparative examples 4 to 6 and Inventive example 2.

FIG. 3 is a graph showing the results of an latent reactive adhesive film investigated, with Inventive example 3.

“At least one”, as used herein refers to 1 or more, as for example 2, 3, 4, 5, 6, 7, 8, 9 or more. In connection with constituents of the compound described herein, this indication refers not to the absolute amount of molecules but instead to the nature of the constituent. “At least one compound containing epoxide groups” therefore denotes, for example, one or more different compounds containing epoxide groups, i.e., one or more different types of compounds containing epoxide groups.

All quantity figures stated in connection with the adhesive described herein relate, unless otherwise indicated, to wt %, based in each case on the total weight of the adhesive. This means that quantity figures of this kind, in connection, for example, with “at least one compound containing epoxide groups”, refer to the total amount of compounds containing epoxide groups that are present in the adhesive.

Numerical values which are reported herein without decimal places relate in each case to the full reported value with one decimal place. For example, “99%” stands for “99.0%”.

The expression “approximately” or “about”, in connection with a numerical value, relates to a variance of ±10% relative to the reported numerical value, preferably ±5%, very preferably ±1%.

The preferred embodiments described below for the individual components (A), (B), (C), (D), (E) and (F) may be applied to all three aspects of the present invention.

These and further aspects, features and advantages of the invention will be apparent to the skilled person from a study of the following detailed description and claims. Any feature from one aspect of the invention may be used in any other aspect of the invention. Additionally it is self-evident that the examples contained herein are intended to describe and illustrate the invention, but not to limit it, and in particular the invention is not confined to these examples.

The term “(co)polymer” is used in the sense of this invention collectively for homopolymers or copolymers. Where the text refers to polymers, the reference is to (co)polymers, unless something different is apparent from the particular reference.

The term “(co)poly(meth)acrylate” refers in the context of this invention to polyacrylate and polymethacrylate homopolymers or to copolymers consisting of (meth)acrylic monomers and also, optionally, further copolymerizable comonomers.

The term “(meth)acrylates” and the adjective “(meth)acrylic” refer collectively to the compounds from the group of acrylic acid derivatives—such as, in particular, acrylic acid esters—and methacrylic acid derivatives—such as, in particular, methacrylic acid esters.

“(Co)polymerizable” in the sense of this invention means the ability of one kind of monomer or of a mixture of at least two kinds of monomers to increase molar mass to form a (co)polymer.

The invention uses, in the adhesive, a (co)polymer (A) which is functionalized with epoxide groups, being functionalized more particularly with one or more aliphatic epoxide groups, and/or an epoxide-containing compound (B) which is different from (A).

(Co)Polymer (A)

The (co)polymer (A) functionalized with epoxide groups is also referred to below simply as (co)polymer (A). With more particular preference it is a (meth)acrylic (co)polymer.

The (co)polymer (A) has a weight-average molar mass of 5 000 g/mol to 5 000 000 g/mol. In preferred embodiments the weight-average molar mass of the (co)polymer (A) is at least 10 000 g/mol, very preferably at least 20 000 g/mol. With further preference the weight-average molar mass of the (co)polymer (A) is at most 500 000 g/mol, preferably 200 000 g/mol, very preferably at most 100 000 g/mol. The weight-average molar mass is determined preferably as below in the experimental section by means of GPC.

In alternative preferred embodiments, the weight-average molar mass of the (co)polymer (A) is at least 500 000 g/mol, very preferably at least 1 000 000 g/mol. With further preference the weight-average molar mass of the (co)polymer (A) is at most 5 000 000 g/mol, preferably 3 500 000 g/mol, very preferably at most 2 000 000 g/mol. Especially if the adhesive comprises less than 0.5 wt %, preferably less than 0.1 wt %, of a matrix polymer (E), especially preferably being free of a matrix polymer (E), based on the total weight of the adhesive.

Corresponding to the proportion in the entirety of the monomers forming the basis for the (co)polymer (A), the (meth)acrylic (co)monomers (a) functionalized with—preferably aliphatic—epoxide groups have a (co)monomer fraction in the (co)polymer (A) of more than 5 to 100 wt %, preferably of at least 10 wt %, very preferably of at least 25 wt %.

The epoxide oxygen atom bridges a C—C bond, or a C—C—C structural group or a C—C—C—C structural group, preferably in all or some of the epoxide groups in at least a portion of the monomers functionalized with—preferably aliphatic—epoxide groups.

The epoxide oxygen atom bridges a C—C bond which is a constituent of an—optionally heterosubstituted—aliphatic hydrocarbon ring (cycloaliphatic epoxide group) preferably in all or some of the epoxide groups in at least a proportion of the monomers functionalized with aliphatic epoxide groups.

Preferably a (meth)acrylic (co)monomer (a) functionalized with an aliphatic epoxide group, and therefore at least one with an aliphatic, preferably cycloaliphatic, epoxide group, is used, or, if there are two or more (meth)acrylic (co)monomers (a) present functionalized with a aliphatic epoxide group, cycloaliphatic epoxides are used for one, two or more or all of these (meth)acrylic (co)monomers (a) functionalized with an aliphatic epoxide group. Cycloaliphatic epoxides are used especially advantageously for more than 50 wt % of the (co)monomers (a), and with particular preference cycloaliphatic epoxides exclusively are used for the (co)monomers (a).

Additionally to monomer (a), the (co)polymer (A) may have been prepared from one or more of the monomers (b), (c), and (d), independently of the presence of the other respective kinds of monomer (b), (c), and (d):

(b) one or more kinds of comonomers having a glass transition temperature of at least 25° C., more particularly at least 50° C.,

with a comonomer fraction in the copolymer of 0 wt % to less than 95 wt %, preferably 0.1 wt % to at most 50 wt %, and/or

(c) one or more Kinds of comonomers having a glass transition temperature of below 25° C., more particularly at most 0° C., with a comonomer fraction in the copolymer of 0 wt % to less than 95 wt %, preferably 0.1 wt % to at most 50 wt %, and/or

(d) one or more kinds of comonomers which carry at least one functionality other than an epoxy group, more particularly a phosphorus- or silicon-containing group, with a comonomer fraction in the copolymer of 0 wt % to 10 wt %, preferably 0.1 wt % to 5 wt %.

Monomer fraction or (co)monomer fraction in the polymer refers, within this specification, to the fraction of the repeating units (building blocks) deriving from these (co)monomers in the polymer in question. The monomer fractions in the polymer mixture to be polymerized for preparing the corresponding polymer are advantageously selected correspondingly.

The fraction of the (co)polymer (A) in the adhesive is preferably at least 5.0 wt % to at most 99.8 wt %, more preferably 10 wt % to 90 wt %, more preferably 20 wt % to 80 wt %, more preferably 30 wt % to 70 wt %, more preferably 40 wt % to 60 wt %.

The glass transition temperature of the (co)polymer (A) is preferably at least 0° C., very preferably at least 25° C., more preferably still at least 35° C. It is preferably at most 100° C., more preferably at most 80° C. In alternative versions of the invention, however, the glass transition temperature of the (co)polymer (A) may also be below 0° C. or above 100° C.

(Co)Monomers (a)

For the (co)monomers (a), monomers of the formula (1)

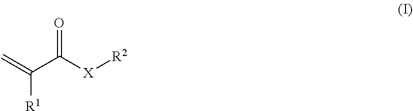

are used, where —R¹ is —H or —CH₃, —X— is —N(R³)— or —O—, —R³ is —H or —CH₃, and —R² is an epoxy-functionalized (hetero)hydrocarbyl group. At least one monomer used has an epoxy-functionalized group, preferably aliphatic and especially preferably a cycloaliphatic group for —R².

With further preference the group R² comprises linear, branched, cyclic or polycyclic hydrocarbons having 2 to 30 carbon atoms that are functionalized with an aliphatic epoxide group. In this case preferably at least one monomer used has an epoxide-functionalized cycloaliphatic group for —R² that has 5 to 30 carbon atoms. Particularly preferred representatives of this group are 3,4-epoxycyclohexyl-substituted monomers such as, for example, 3,4-epoxycyclohexylmethyl methacrylate, 3,4-epoxycyclohexylmethyl acrylate, 3,4-epoxycyclohexyl methacrylate, 3,4-epoxycyclohexyl acrylate. Oxetane-containing (meth)acrylates and oxolane-containing (meth)acrylates can likewise be used. Comonomers (a) in the (co)polymer (A) are employed at not less than 5 wt %, preferably not less than 10 wt %, very preferably not less than 25 wt %.

Comonomers (b) for optional use Comonomers (b) in particular have no epoxy groups. For the comonomers (b) it is possible to use all (meth)acrylate monomers and other copolymerizable vinyl monomers—especially those free from epoxy groups—that are known to the skilled person and that are copolymerizable with (co)monomers (a) and any comonomers (c) and/or (d) and/or (e) present, and that have a glass transition temperature—as the hypothetical homopolymer (in this context, the glass transition temperature referred to is that of the homopolymer of the corresponding monomers in the molar mass-independent glass transition temperature range, T_{g}^{∞}) of at least 25° C., more particularly at least 50° C. Monomers of these kinds are also referred to in the context of this specification as “hard monomers”. For the selection of such comonomers it is possible, for example, to consult the Polymer Handbook (J. Brandrup, E. H. Immergut, E. A. Grulke (Eds.), 4th edn., 1999, J. Wiley, Hoboken, Vol. 1, chapter VI/193). Also advantageously employable are so-called macromers according to WO 2015/082143 A1. Preferred comonomers are those which by virtue of their chemical construction have substantially no reactivity with the epoxide functionalities of the (co)monomers (a) prior to the initiation of the curing reaction, or have no initiating or catalyzing effect in relation to reaction of the epoxy functionalities, or whose reactivity with epoxide functionalities is otherwise prohibited.

Comonomers (c) for Optional Use

Comonomers (c) in particular have no epoxy groups. For the comonomers (c) it is possible to use all (meth)acrylate monomers and other copolymerizable vinyl monomers—especially those free from epoxy groups—that are known to the skilled person and that are copolymerizable with (co)monomers (a) and any comonomers (b) and/or (d) present, and that have a glass transition temperature—as the hypothetical homopolymer (in this context, the glass transition temperature referred to is that of the homopolymer of the corresponding monomers in the molar mass-independent glass transition temperature range, T_{g}^{∞}) of below 25° C., more particularly at most 0° C. Monomers of these kinds are also referred to in the context of this specification as “soft monomers”. For the selection of such comonomers it is possible, for example, to consult the Polymer Handbook (J. Brandrup, E. H. Immergut, E. A. Grulke (Eds.), 4th edn., 1999, J. Wiley, Hoboken, Vol. 1, chapter VI/193). Also advantageously employable are so-called macromers according to WO 2015/082143 A1. Preferred comonomers are those which by virtue of their chemical construction have substantially no initiating or catalyzing action in relation to a reaction of the epoxide functionalities prior to the initiation of the curing reaction, more particularly which have no reactivity with the epoxide functionalities of the (co)monomers (a), and/or whose reactivity with epoxide functionalities is otherwise prohibited.

Comonomers (d) for Optional Use

As the comonomers (d) it is additionally possible for monomers to be employed that are copolymerizable with (co)monomers (a) and with any comonomers (b) and/or (c) present, and that optimize the adhesive properties of the copolymers of the invention. Particularly advantageous in this context are phosphorus-containing and silicon-containing comonomers and, among the latter, acrylated or methacrylated alkoxysilane-containing comonomers. Examples are 3-(triethoxysilyl)propyl methacrylate, 3-(triethoxysilyl)propyl acrylate, 3-(trimethoxysilyl)propyl acrylate, 3-(trimethoxysilyl)propyl methacrylate, methacryloxymethyltriethoxysilane, (methacryloxymethyl)trimethoxysilane, (3-acryloxypropyl)methyldimethoxysilane, (methacryloxymethyl)methyldimethoxysilane, γ-methacryloxypropylmethyldimethoxysilane, methacryloxypropylmethyldiethoxysilane, 3-(dimethoxymethylsilyl)propyl methacrylate, methacryloxypropyldimethylethoxysilane, methacryloxypropyldimethylmethoxysilane. Particularly preferred among the aforesaid compounds are 3-(triethoxysilyl)propyl methacrylate, 3-(triethoxysilyl)propyl acrylate, 3-(trimethoxysilyl)propyl acrylate and 3-(trimethoxysilyl)propyl methacrylate. The comonomers (d) also preferably have no glycidyl ether or epoxy groups. The fraction of comonomers (d) is preferably at most 10 wt %, based on the total weight of the copolymer. In one advantageous configuration of this invention, a (co)polymer comprises comonomer (d). In a further advantageous configuration of this invention, comonomers (d) are omitted entirely.

In one preferred embodiment the (co)polymer (A) contains no Si-containing monomers. In another preferred embodiment the (co)polymer (A) is tacky.

Preparation

The (co)polymers (A) are prepared by (co)polymerization of the constituent (co)monomers and may be prepared in bulk, in the presence of one or more organic solvents, in the presence of water or in mixtures of organic solvents and water. The aim here is to minimize the amount of solvent used. Suitable organic solvents are pure alkanes (for example, hexane, heptane, octane, isooctane, isohexane, cyclohexane), aromatic hydrocarbons (for example, benzene, toluene, xylene), esters (for example, ethyl acetate, propyl, butyl or hexyl acetates), halogenated hydrocarbons (for example, chlorobenzene), alkanols (for example, methanol, ethanol, ethylene glycol, ethylene glycol monomethyl ether), ketones (e.g. acetone, butanone) and ethers (for example, diethyl ether, dibutyl ether) or mixtures thereof. No compounds are used that can react with epoxide functionalities before the initiation of the curing reaction or that may initiate or catalyze the reaction of epoxide functionalities, or their reactivity with epoxide functionalities is otherwise prohibited.

The aqueous polymerization reactions may be admixed with a water-miscible or hydrophilic cosolvent, in order to ensure that the reaction mixture is in the form of a homogeneous phase during monomer conversion. Cosolvents which can be used advantageously for the present invention are selected from the following group, consisting of aliphatic alcohols, glycols, ethers, glycol ethers, polyethylene glycols, polypropylene glycols, esters, alcohol derivates, hydroxyether derivates, ketones and the like and also derivatives and mixtures thereof. No compounds are used that can react with epoxide functionalities and/or that may initiate or catalyze the reaction of epoxide functionalities and/or whose reactivity with epoxide functionalities is otherwise prohibited.

The (co)polymers (A) of the invention are advantageously prepared using conventional radical polymerizations or controlled radical polymerizations. For the polymerizations proceeding by radical mechanism, preference is given to using initiator systems which comprise radical initiators for the polymerization (polymerization initiators), especially radical-forming azo or peroxo initiators which decompose thermally. Suitable in principle, however, are all customary polymerization initiators that are familiar to the skilled person for acrylates and/or methacrylates. The production of C-centered radicals is described in Houben-Weyl, Methoden der Organischen Chemie, Vol. E 19a, pp. 60-147. These methods are preferably applied analogously.

The radical polymerization initiators referred to in connection with the preparation of the (co)polymers (A) should not be confused with the activators or curing agents employed for curing the curable adhesive.

Examples of radical sources are peroxides, hydroperoxides and azo compounds. Some nonexclusive examples of typical radical initiators that may be mentioned here include potassium peroxodisulfate, dibenzoyl peroxide, cumene hydroperoxide, cyclohexanone peroxide, di-tert-butyl peroxide, azobisisobutyronitrile, cyclohexylsulfonyl acetyl peroxide, diisopropyl percarbonate, tert-butyl peroctoate, benzopinacol. Particularly preferred for use as radical polymerization initiator is 2,2′-azobis(2-methylbutyronitrile) or 2,2-azobis-(2,4-dimethylvaleronitrile).

The polymerization time, depending on temperature and desired conversion, is between 4 and 72 hours. The higher the reaction temperature that can be selected, in other words the higher the thermal stability of the reaction mixture, the lower the reaction time that can be selected.

The introduction of heat is essential for initiating the polymerization in the case of the thermally decomposing polymerization initiators. For the thermally decomposing polymerization initiators, the polymerization can be initiated by heating to 50° C. or more, depending on initiator type. A preferred initiation temperature is at most 100° C., very preferably at most 80° C.

Employed for radical stabilization in a favorable procedure are nitroxides, such as, for example, (2,2,5,5-tetramethyl-1-pyrrolidinyl)oxyl (Proxyl), (2,2,6,6-tetramethyl-1-piperidinyl)oxyl (Tempo), derivates of Proxyl or of Tempo, and other nitroxides familiar to the skilled person.

A series of further polymerization methods whereby the adhesives can be produced in an alternative procedure may be selected from the prior art: WO 96/24620 A1 describes a polymerization process using very specific radical compounds such as, for example, phosphorus-containing nitroxides based on imidazolidine. WO 98/44008 A1 discloses specific nitroxyls which are based on morpholines, piperazinones and piperazine diones. DE 199 49 352 A1 describes heterocyclic alkoxyamines for use as regulators in controlled radical polymerizations.

A further controlled polymerization method which can be used is that of atom transfer radical polymerization (ATRP), using preferably monofunctional or difunctional secondary or tertiary halides as polymerization initiator and, for abstracting the halide(s), complexes of Cu, Ni, Fe, Pd, Pt, Ru, Os, Rh, Co, Ir, Ag or Au. The various possibilities of ATRP are also described in the specifications of U.S. Pat. No. 5,945,491 A, of U.S. Pat. No. 5,854,364 A and of U.S. Pat. No. 5,789,487 A.

A further preparation process carried out is a variant of the RAFT polymerization (reversible addition-fragmentation chain transfer polymerization). The polymerization process is described thoroughly for example in the specifications WO 98/01478 A1 and WO 99/31144 A1. Suitable with particular advantage for the preparation are trithiocarbonates of the general structure R′″—S—C(S)—S—R′″ (Macromolecules, 2000, 33, 243-245).

One very advantageous variant makes use, for example, of the trithiocarbonates (TTC1) and (TTC2) or the thio compounds (THI1) and (THI2) for polymerization, where Φ may be a phenyl ring, which may be unfunctionalized or functionalized by alkyl or aryl substituents, linked directly or by way of ester or ether bridges, or may be a cyano group or a saturated or unsaturated aliphatic radical. Phenyl ring Φ may optionally carry one or more polymer blocks, examples being polybutadiene, polyisoprene or polystyrene, to name but a few. Functionalizations may be, for example, halogens, hydroxyl groups, epoxide groups, without this listing making any claim to completeness.

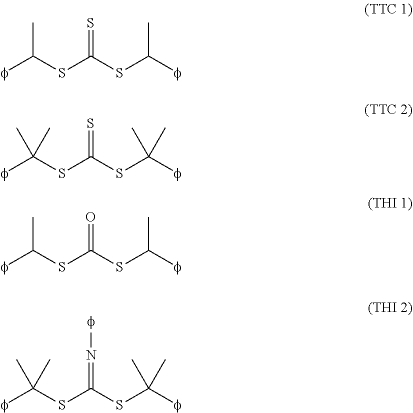

In connection with the abovementioned polymerizations proceeding by a controlled radical mechanism, preferred polymerization initiator systems are those which comprise radical polymerization initiators, especially the above-recited thermally decomposing, radical-forming azo or peroxo initiators. Suitable in principle for this purpose, however, are all customary polymerization initiators known for acrylates and/or methacrylates. It is also possible, moreover, to use radical sources which release radicals only under UV irradiation. It is critical that these polymerization initiators are not able to activate any reaction of the epoxide functionalities.

For the purpose of adjusting the molar masses it is also possible to use prior-art chain transfer reagents, provided they have no reactivity toward epoxide groups or their reactivity with epoxide groups is otherwise prohibited.

The desired molar mass is adjusted preferably by polymerization processes, whether controlled or uncontrolled polymerization processes, which do not use any agents which can react with epoxide functionalities before the curing reaction of the adhesive film is initiated, or can initiate or catalyze the reaction of epoxide functionalities, or their reactivity with epoxide functionalities is otherwise prohibited.

The desired molar mass may be adjusted, moreover and with particular preference, via the ratio of use of polymerization initiators and (co)monomer(s) and/or the concentration of (co)monomers.

Compound (B) Containing Epoxide Groups

Particularly preferred are (co)polymers (B1) containing glycidyl ether groups, and/or other glycidyl ethers (B2) and/or epoxides (B3).

(Co)polymers (B1) containing glycidyl ether groups may be obtained in analogy to the above-described (co)polymers (A), except that the monomer (a) is replaced by a monomer (e) containing glycidyl ether groups or supplemented by a monomer (e) containing glycidyl ether groups. Especially preferred as monomers (e) are glycidyl acrylate or glycidyl methacrylate. All preferred embodiments for the above-described (co)polymer (A) in terms of the monomers (b), (c) and (d) and also the properties of the (co)polymer such as the weight-average molar mass, for example, are preferred as described above for (A). This molar mass, then, is typically at least 5000 g/mol and at most 5 000 000 g/mol.

Preferred glycidyl ethers (B2) are at least difunctional or tri-, tetra- or more highly polyfunctional in respect of the glycidyl ether groups the compound contains, and have a molecular weight of 58 to below 5 000 g/mol, preferably 58 to 1 000 g/mol. Examples of those suitable include diglycidyl ethers of a polyoxyalkylene glycol, or glycidyl ether monomers. Examples are the glycidyl ethers of polyhydric phenols, which are obtained by reaction of a polyhydric phenol with an excess of chlorohydrin, such as epichlorohydrin (e.g., the diglycidyl ether of 2,2-bis-(2,3-epoxypropoxyphenolpropane).

Further examples which can be used are diglycidyl tetrahydrophthalate and derivates, diglycidyl hexahydrophthalate and derivates, 1,2-ethane diglycidyl ether and derivates, 1,3-propane diglycidyl ether and derivates, 1,4-butanediol diglycidyl ether and derivates, higher 1,n-alkane diglycidyl ethers and derivates, diglycidyl 4,5-epoxytetrahydrophthalate and derivates, bis-[1-ethyl(3-oxetanyl)methyl] ether and derivates, pentaerythritol tetraglycidyl ether and derivates, bisphenol A diglycidyl ether (DGEBA), hydrogenated bisphenol A diglycidyl ether, bisphenol F diglycidyl ether, hydrogenated bisphenol F diglycidyl ether, epoxyphenol novolacs, hydrogenated epoxyphenol novolacs, epoxycresol novolacs, hydrogenated epoxycresol novolacs, 2-(7-oxabicyclospiro(1,3-dioxane-5,3′-(7-oxabicyclo[4.1.0]-heptane)), 1,4-bis((2,3-epoxypropoxy)methyl)cyclohexane.

Preferred epoxides (B3) contain epoxide groups, have a molecular weight of 58 to below 5 000 g/mol, preferably 58 to 1 000 g/mol, and are different from (B2).

The fraction of (B) in the adhesive in one preferred version is at least 5.0 wt % to at most 99.8 wt %, more preferably 10 wt % to 90 wt %, more preferably 20 wt % to 80 wt %, more preferably 30 wt % to 70 wt %, more preferably 40 wt % to 60 wt %.

If both (A) and (B) are present, the overall fraction thereof is preferably at least 5.0 wt % to at most 99.8 wt %, more preferably 10 wt % to 90 wt %, more preferably 20 wt % to 80 wt %, more preferably 30 wt % to 70 wt %, more preferably 40 wt % to 60 wt %.

Radical Initiator (C)

The adhesive further comprises at least one specific radical initiator (C) The radical initiator (C) according to the present invention preferably comprises at least two organyl groups.

Especially suitable radical initiators (C) are peroxides (C1) and azo compounds (C2).

The peroxides (C1) are more particularly those which carry an organyl group on each oxygen atom. Preferred for use as peroxides, accordingly, are compounds of the general structure R—O—O—R′, where the radicals R and R′ are organyl groups, which may be selected independently of one another or else may be identical, and where R and R′ may also be joined to one another, to form a ring with R and R′ via the peroxy group (—O—O—). The peroxide (C1) preferably has a 1-minute half-life temperature in solution of less than 200° C.

Organyl groups are organic radicals—irrespective of which functional group is present therein—having one, or less often, two or more free valences on a carbon atom. Examples thereof are acetonyl groups, acyl group (for example, acetyl groups, benzoyl groups), alkyl groups (for example, methyl groups, ethyl groups), alkenyl group (for example, vinyl groups, allyl groups), alkynyl groups (propargyl groups), aminocarbonyl groups, ampicilloyl groups (radicals derived from ampicillin), aryl groups (for example, phenyl groups, 1-naphthyl groups, 2-naphthyl groups, 2-thiophenyl groups, 2,4-dinitrophenyl groups), alkylaryl groups (for example, benzyl groups, triphenylmethyl groups), benzyloxycarbonyl groups (Cbz), tert-butoxycarbonyl groups (Boc), carboxyl groups, (fluoren-9-ylmethoxy)carbonyl groups (Fmoc), furfuryl groups, glycidyl groups, haloalkyl groups (for example, chloromethyl groups, 2,2,2-trifluoroethyl groups), indolyl groups, nitrile groups, nucleosidyl groups, trityl groups, to name but a few.

In comparison to the hydroperoxides, for example, peroxides of the general structure R—O—O—R′ (including those in cyclic form) have the advantage that on thermal activation of the adhesive they do not release water as primary elimination product. In accordance with the invention it is preferred to reduce as far as possible, and preferably to avoid completely, volatile constituents having boiling points below 120° C., preferably having boiling points below 150° C., in order in particular to avoid blistering at the bond site and hence weakening at that point. Accordingly, with particular preference, R and R′ in the peroxides of the invention should be selected such that they as well do not result in the formation of highly volatile primary elimination products—such as carbon dioxide and isopropanol, for example.

In accordance with the invention the at least one radical initiator, or the two or more radical initiators used, is or are preferably selected such as to possess comparatively high decomposition rates or low half-lives [t_{1/2}] at elevated temperatures—temperatures above their activation temperature. The decomposition rate of the radical initiators is a characteristic criterion of their reactivity and is quantified by the statement of the half-lives at certain temperatures [t_{1/2}(T)], with the half-life, as usual, representing the time after which half of the radical initiator has undergone decomposition under the specified conditions. The higher the temperature, the lower in general is the half-life of decomposition. Consequently, the higher the decomposition rate, the lower the half-life. The half-life temperature [T(t_{1/2})] is the temperature at which the half-life corresponds to a specified value—for example, the 10-hour half-life temperature [T(t_{1/2}=10 h)] is the temperature at which the half-life of the compound under investigation amounts to exactly 10 hours, and the 1-minute half-life temperature [T(t_{1/2}=1 min)] is the temperature at which the half-life of the compound under investigation is exactly 1 minute, and so on.

In preferred embodiments the at least one radical initiator, or the two or more radical initiators used, is or are selected such that the 1-minute half-life temperature T(t_{1/2}=1 min) in solution does not exceed 200° C., preferably not exceeding 190° C. and very preferably not exceeding 180° C.

The above condition is deemed to have been met in particular when the peroxide in question has a corresponding half-life temperature value at least in monochlorobenzene (0.1 molar solution). Such half-lives can be ascertained experimentally (determination of concentration by means of DSC or titration) and can also be found in the relevant literature. The half-lives are additionally obtainable by calculation from the constants of Arrhenius frequency factor and decomposition activation energy specific to the particular peroxide for the specified conditions in each case. The relations here are as follows:

−dc/dt=k·c [1]

ln(c₁/c₀)=−k·t [2]

t_{1/2}=ln 2/k for cₜ(t_{1/2})=c₀/2 [3]

k=A·e^{-Ea/RT} [4]
where c₀=initial concentration
   cₜ=concentration at time t
   cₜ(t_{1/2})=concentration at the half-life time
   t_{1/2}=half-life
   k=decomposition constant
   A=Arrhenius frequency factor
   Ea=activation energy for peroxide decomposition
   R=general gas constant (R=8.3142 J/(mol·K))
   T=absolute temperature

The half-lives and half-life temperatures stated in this specification are based in each case on a 0.1 molar solution of the corresponding peroxide in monochlorobenzene, unless otherwise indicated individually.

By way of the constants of Arrhenius frequency factor and decomposition activation energy, which can be researched or calculated from researchable values for the respective conditions—such as the solvent used—it is possible to convert the half-lives and the half-life temperatures to other respective conditions—such as in other solvents—and so to make them comparable.

The radical initiators used are preferably initiators which also possess high half-lives at moderate temperatures—particularly those well below their activation temperatures. In this way it is possible to achieve good latency, i.e., an effective storage stability on the part of the thermally activatable adhesive sheets comprising the radical initiators. Accordingly, the at least one radical initiator, or the two or more radical initiators used, is or are preferably selected such that its or their half-life at 80° C.—i.e., after a preliminary laminating operation, for instance—is at least 13.5 hours, more particularly at least 22.5 hours, preferably at least 69 hours, more preferably at least 700 hours. This allows the thermally activatable adhesive tape at 80° C. to have a sufficient working time and application time in that after an hour at least 95% of the radical initiator originally used (corresponding to t_{1/2}=13.5 h), more particularly at least 97% (corresponding to t_{1/2}=22.5 h), preferably at least 99% (corresponding to t_{1/2}=69 h), and more preferably at least 99.9% of the radical initiator used is still present and is therefore not yet available for a reaction.

In order to guarantee a storage-stable system, the half-life under customary storage conditions—which may customarily be about up to 40° C.—ought to be high. The radical initiators used ought therefore preferably to be selected such that their half-life at the storage temperature, preferably at up to 40° C., is still sufficient that after 9 months (27 days) at least 75%, preferably 85%, more preferably 95% or very preferably more than 95% of the radical initiator is still available for crosslinking. The corresponding half-lives can be ascertained using the relations identified above.

Examples of radical initiators suitable in accordance with the invention are representatives from the following groups:

Dialkyl peroxides, diacyl peroxides, peroxy esters, peroxydicarbonates, peroxyketals, cyclic peroxides, for which the stated values in respect of 1-minute half-life temperature, preferably also in respect of half-life at 80° C., and more preferably in respect of half-life at 40° C. as well are realized.

Specified below illustratively are a number of representatives in the various groups to which this applies, these representatives being advantageously employable in accordance with the invention:

Dialkyl peroxides: Di-tert-amyl peroxide, di-tert-butyl peroxide, tert-butyl cumyl peroxide, dicumyl peroxide, 2,5-dimethyl-2,5-di-(tert-butyl peroxy)hexane, 2,5-dimethyl-2,5-di(tert-butylperoxy)-hex-3-yn, di-(2-tert-butylperoxyisopropyl)benzene; Diacyl peroxides: dibenzoyl peroxide, dilauroyl peroxide, diisobutyryl peroxide, didecanoyl peroxide, di-(3,5,5-trimethylhexanoyl) peroxide; Ketone peroxides: acetylacetone peroxide, cyclohexanone peroxide, methyl ethyl ketone peroxide, methyl isobutyl ketone peroxide;

Peroxy esters: tert-butyl peroxyacetate, tert-butyl peroxybenzoate, tert-butylperoxydiethyl acetate, tert-amyl peroxy-2-ethylhexyl carbonate, tert-butyl peroxyisopropyl carbonate, tert-butyl peroxy-2-ethylhexyl carbonate, tert-amyl peroxy-2-ethylhexanoate, tert-butyl peroxy-2-ethylhexanoate, 1,1,3,3-tetramethylbutyl peroxy-2-ethylhexanoate, tert-butyl peroxy-3,5,5-trimethylhexanoate, tert-butyl peroxyisobutyrate, tert-butyl monoperoxymaleate, tert-amyl peroxineodecanoate, tert-butyl peroxyneodecanoate, cumene peroxyneodecanoate, 1,1,3,3-tetramethylbutyl peroxyneodecanoate, tert-butyl peroxyneoheptanoate, tert-amyl peroxypivalate, tert-butyl peroxypivalate, 1,1,3,3-tetramethylbutyl peroxypivalate, 2,5-dimethyl-2.5-di(2-ethylhexanoylperoxy)hexane;

Peroxy dicarbonates: di-n-peroxidicarbonate, di-(2-ethylhexyl) peroxydicarbonate, di-n-butyl peroxydicarbonate, dicetyl peroxydicarbonate, dimyristyl peroxydicarbonate, di-(4-tert-butylcyclohexyl) peroxydicarbonate;

Peroxyketals: 1,1-di-(tert-butylperoxy)-3,3,5-trimethylcyclohexane, 1,1-di-(tert-butylperoxy)-cyclohexane, 2,2-di-(tert-butylperoxy) butane;

Cyclic peroxides: 3,6,9-triethyl-3,6,9-trimethyl-1,4,7-triperoxonane.

Used with particular advantage in accordance with the invention is dicumyl peroxide (bis(1-methyl-1-phenylethyl) peroxide). This compound has the following half-lives: 812 h at 80° C. (corresponding to less than 0.1% of the original amount of peroxide at 80° C. within one hour); 10 h at 112° C.; 1 h at 132° C.; 0.1 h=6 min at 154° C.; 1 min at 172° C.; all the aforesaid values in solution (0.1 molar monochlorbenzene). Dicumyl peroxide is selected with particular preference since it allows particularly storage-stable adhesive films to be obtained which are also resistant to combined heat and humidity. Two or more radical initiators may also be used. In that case, preferably, dicumyl peroxide is selected as one of the two or more radical initiators.

Suitable azo compounds (C2) in principle are all customary azo initiators known to the skilled person for (meth)acrylates, such as those, for example, disclosed in Houben Weyl, Methoden der Organischen Chemie, Vol. E 19a, pp. 60-147.

The radical initiator or initiators used, especially dicumyl peroxide, are selected preferably—depending in particular on their reactivity—in an amount such that the resulting bond produced using the adhesive film has the desired properties and more particularly fulfills the specifications defined in more detail later on below, in the push-out tests. The adhesives used in the invention and the corresponding adhesive films have latent reactivity. Latent reactivity in the sense of this invention refers to those activatable adhesive systems which without activation can be stored stably over prolonged periods. Latent reactive adhesive films are preferably those which under standard conditions (23° C. [296.15 K]; 50% rh) and especially at elevated storage temperatures (in particular up to 40° C. [316.15 K]) do not cure or cure only over a period of several weeks, preferably months, and are therefore storage-stable, but which at higher temperatures can be activated, and undergo curing and/or crosslinking. The latent reactivity offers the advantage that these adhesive films can be stored, transported and further processed (converted, for example) under standard conditions and particularly at elevated temperatures of up to 40° C., before they are then employed at the bonding site and cured.

During the storage time, the adhesives are not to undergo significant alteration, so that the bonding properties of an adhesive system employed for bonding freshly after production, and those of an adhesive system employed after long storage for the otherwise comparable bonding, exhibit no substantial differences from one another, but in particular at least still meet the profile of requirements (Push-Out>1.5 MPa), still having preferably at least 50%, more preferably at least 75% and very preferably at least 90% of the performance of the unstored adhesive film.

With further preference the films of adhesive are also resistant in terms of the defined heat-and-humidity behavior, therefore exhibiting only tolerable deviations from the corresponding values for an adhesive assembly of correspondingly stored adhesive films that has not undergone heat-and-humidity storage, the values in question being those in the push-out test of the bonded assembly even after prolonged storage of the adhesive film, prior to production of the assembly, for at least 3 weeks, preferably at least 4 weeks, at 40° C. in a suitable standard commercial air convection drying cabinet (drying cabinet is under standard conditions (23° C. and 50% rh)), and after further storage of the produced bonded assembly under heat-and-humidity conditions (72 h at 85° C. and 85% rh).

Preferably, moreover, in combination with the aforesaid minimum values, the bond strength—in the sense of the aforesaid push-out force value—of the bonded assembly after heat-and-humidity storage ought to be more than 50% of that of the bonded assembly not stored under heat-and-humidity conditions, and more preferably the bond strength of the bonded assembly stored under heat-and-humidity conditions ought to be more than 75% of that of the bonded assembly not stored under heat-and-humidity conditions, and very preferably the bond strength of the bonded assembly stored under heat-and-humidity conditions ought to be more than 90% of the value, or even to exceed the value, of the bonded assembly not stored under heat-and-humidity conditions.

The compositions of the invention are notable in that on the one hand they have latent reactivity and on the other hand are rapidly curable at elevated temperature. To fulfill these requirements, amounts of radical initiator—for example the amount of dicumyl peroxide—of at least 0.1 wt % have emerged as being very advantageous, advantageously at least 1 wt %, more advantageously at least 2 wt %, very advantageously at least 3 wt %, and at most 10 wt %, preferably at most 8 wt %, very preferably at most 7 wt %.

Photoacid Generators (D)

Photoacid generators are familiar to the skilled person, and preferably at least one of the compounds listed below is used. As photo acid generators for a cationic, UV-induced curing, it is possible in particular to employ sulfonium-, iodonium- and metallocene-based systems. As examples of sulfonium-based cations, reference may be made to the observations in U.S. Pat. No. 6,908,722 B1 (especially columns 10 to 21).

Photo acid generators (also called “photocation generators” or “photoinitiators”) used preferably likewise include aryldiazonium salts (“onium salts”), which may be represented generally by the formula Ar—N═N+LX″, wherein LX″ is an adduct of a Lewis acid L and a Lewis base X″. Particularly advantageous are BF4 ˜, SbF5, AsF5˜PF5, SO₃CF₂˜ for LX″. Under the effect of UV radiation, there is a rapid cleaving of the molecule to give the aryl halide (ArX), nitrogen and the corresponding Lewis acid.

Also known for use as cationic photoinitiators are aryliodonium salts (C₆H₅)RI+LX″, where R is an organic radical, and more particularly diaryliodonium salts (C₆H₅)₂I+LX″, and triarylsulfonium salts (C₆H₅)₃S+LX″; in the presence of proton donors, these salts form strength (Brönsted) acids, which are likewise highly suitable for initiating cationic polymerizations and for the inventive method.

Sulfonium salts as cation photoinitiators also take the form, for example, of the compounds H₅C₆—CO—CH₂—S+LX″ or H₅C₆—CO—CH₂-Pyr+LX″, where Pyr represents a nitrogen-containing heteroaromatic system (e.g., pyridine, pyrimidine).

In preferred embodiments the photo acid generator is a triarylsulfonium hexafluoro salt from group 15 of the periodic table, with the group 15 element being preferably in the IV oxidation state. Employed very favorably are triarylsulfonium hexafluorophosphate and/or triarylsulfonium hexafluoroantimonate.

Examples of anions serving as counterions include tetrafluoroborate, tetraphenylborate, hexafluorophosphate, perchlorate, tetrachloroferrate, hexafluoroarsenate, hexafluoroantimonate, pentafluorohydroxyantimonate, hexachloroantimonate, tetrakispentafluorophenylborate, tetrakis(pentafluoromethylphenyl)borate, bi(trifluoromethylsulfonyl) amides and tris(trifluoromethylsulfonyl) methides. Also conceivable as anions, furthermore, particularly for iodonium-based initiators, are chloride, bromide or iodide, although preferred initiators are those which are substantially free from chlorine and bromine.

Examples of preferable photo acid generators are the following compounds: Sulfonium salts (see, for example, U.S. Pat. Nos. 4,231,951 A, 4,256,828 A, 4,058,401 A, 4,138,255 A and US 2010/063221 A1) such as triphenylsulfonium hexafluoroarsenate, triphenylsulfonium hexafluoroborate, triphenylsulfonium tetrafluoroborate, triphenylsulfonium tetrakis(pentafluorobenzyl)borate, methyldiphenylsulfonium tetrafluoroborate, methyldiphenylsulfonium tetrakis(pentafluorobenzyl)borate, dimethylphenylsulfonium hexafluorophosphate, triphenylsulfonium hexafluorophosphate, triphenylsulfonium hexafluoroantimonate, diphenylnaphthylsulfonium hexafluoroarsenate, tritolylsulfonium hexafluorophosphate, anisyldiphenylsulfonium hexafluoroantimonate, 4-butoxyphenyldiphenylsulfoniumtetrafluoroborate, 4-chlorophenyldiphenylsulfonium hexafluoroantimonate, tris(4-phenoxyphenyl)sulfonium hexafluorophosphate, di-(4-ethoxyphenyl)methylsulfonium hexafluoroarsenate, 4-acetylphenyldiphenylsulfoniumtetrafluoroborate, 4-acetylphenyldiphenylsulfoniumtetrakis-(pentafluorobenzyl)borate, tris(4-thiomethoxyphenyl)sulfonium hexafluorophosphate, di (methoxysulfonylphenyl)methylsulfonium hexafluoroantimonate, di(methoxynaphthyl)methylsulfoniumtetrafluoroborate, di(methoxynaphthyl)-methylsulfoniumetrakis-(penta-fluorobenzyl)borate, di-(carbomethoxyphenyl)-methylsulfonium hexafluorophosphate, (4-octyloxyphenyl)-diphenylsulfoniumtetrakis-(3,5-bis-trifluoromethylphenyl)borate, tris-[4-(4-acetylphenyl)-thiophenyl]-sulfoniumtetrakis-(pentafluorophenyl)borate, tris-(dodecyl-phenyl)-sulfoniumtetrakis-(3,5-bis-trifluoromethylphenyl)borate, 4-acetamidophenyldiphenylsulfonium tetrafluoroborate, 4-acetamidphenyldiphenylsulfonium tetrakis(pentafluorobenzyl)borate, dimethylnaphthylsulfonium hexafluorophosphate, trifluoromethyldiphenyl-sulfoniumtetrafluoroborate, trifluoromethyldiphenylsulfoniumtetrakis-(pentafluorobenzyl)borate, phenylmethylbenzylsulfonium hexafluorophosphate, 5-methylthianthreniumhexafluorophosphate, 10-phenyl-9,9-dimethylthioxanthenium hexafluorophosphate, 10-phenyl-9-oxothioxantheniumtetrafluoroborate, 10-phenyl-9-oxothioxantheniumtetrakis-(pentafluoro-benzyl)borate, 5-methyl-10-oxothianthreniumtetrafluoroborate, 5-methyl-10-oxothianthrenium tetrakis(pentafluorobenzyl)borate and 5-methyl-10,10-dioxothianthrenium hexafluorophosphate; iodonium salts (see, for example, U.S. Pat. Nos. 3,729,313 A, 3,741,769 A, 4,250,053 A, 4,394,403 A and US 2010/063221 A1) such as diphenyliodonium tetrafluoroborate, di(4-methylphenyl)iodonium tetrafluoroborate, phenyl-4-methylphenyliodonium tetrafluoroborate, di(4-chlorophenyl)iodonium hexafluorophosphate, dinaphthyliodonium tetrafluoroborate, di(4-trifluormethylphenyl)iodonium tetrafluoroborate, diphenyliodonium hexafluorophosphate, di(4-methylphenyl)iodonium hexafluorophosphate, diphenyliodonium hexafluoroarsenate, di(4-phenoxyphenyl)iodoniumtetrafluoroborate, phenyl-2-thienyliodonium hexafluorophosphate, 3,5-dimethylpyrazolyl-4-phenyliodonium hexafluorophosphate, diphenyliodonium hexafluoroantimonate, 2,2′-diphenyliodoniumtetrafluoroborate, di(2,4-dichlorphenyl)iodonium hexafluorophosphate, di(4-bromophenyl)iodonium hexafluorophosphate, di(4-methoxyphenyl)iodonium hexafluorophosphate, di(3-carboxyphenyl)iodonium hexafluorophosphate, di(3-methoxycarbonylphenyl)iodonium hexafluorophosphate, di(3-methoxysulfonylphenyl)iodonium hexafluorophosphate, di(4-acetamidophenyl)iodonium hexafluorophosphate, di(2-benzothienyl)iodonium hexafluorophosphate, diaryliodonium tristrifluoromethylsulfonylmethide such as diphenyliodonium hexafluoroantimonate, diaryliodonium tetrakis(pentafluorophenyl)borate such as diphenyliodonium tetrakis(pentafluorophenyl)borate, (4-n-desiloxyphenyl)phenyliodonium hexafluoroantimonate, [4-(2-hydroxy-n-tetradesiloxy)-phenyl]phenyliodonium hexafluoroantimonate, [4-(2-hydroxy-n-tetradesiloxy)-phenyl]-phenyliodoniumtrifluorosulfonate, [4-(2-hydroxy-n-tetradesiloxy)-phenyl]-phenyliodonium hexafluorophosphate, [4-(2-hydroxy-n-tetradesiloxy)-phenyl]-phenyliodoniumtetrakis-(pentafluorophenyl)borate, bis-(4-tert-butylphenyl)iodonium hexafluoroantimonate, bis-(4-tert-butylphenyl)iodonium hexafluorophosphate, bis-(4-tert-butylphenyl)-iodoniumtrifluorosulfonate, bis-(4-tert-butylphenyl)-iodoniumtetrafluoroborate, bis-(dodecylphenyl)-iodonium hexafluoroantimonate, bis-(dodecylphenyl)-iodoniumtetrafluoroborate, bis-(dodecylphenyl)-iodonium hexafluorophosphate, bis-(dodecylphenyl)-iodoniumtrifluoromethylsulfonate, di-(dodecylphenyl)-iodonium hexafluoroantimonate, di-(dodecylphenyl)-iodoniumtriflate, diphenyliodoniumbisulfate, 4,4′-dichlorodiphenyliodoniumbisulfate, 4,4′-dibromodiphenyliodoniumbisulfate, 3,3′-dinitrodiphenyliodoniumbisulfate, 4,4′-dimethyldiphenyliodoniumbisulfate, 4,4′-bis-succinimidodiphenyliodoniumbisulfate, 3-nitrodiphenyliodoniumbisulfate, 4,4′-dimethoxydiphenyliodonium bisulfate, bis(dodecylphenyl)iodonium tetrakis(pentafluorophenyl)borate, (4-octyloxyphenyl)phenyliodonium tetrakis(3,5-bis-trifluoromethylphenyl)borate and (tolylcumyl)iodonium tetrakis(pentafluorophenyl)borate; and ferrocenium salts (see, for example, EP 0 542 716 B1) such as n5-(2,4-cyclopentadien-1-yl)-[(1,2,3,4,5,6,9)-(1-methylethyl)benzene] iron.

Examples of commercialized photoinitiators are Cyracure UVI-6990, Cyracure UVI-6992, Cyracure UVI-6974 and Cyracure UVI-6976 from Union Carbide, Optomer SP-55, Optomer SP-150, Optomer SP-151, Optomer SP-170 and Optomer SP-172 from Adeka, San-Aid SI-45L, San-Aid SI-60L, San-Aid SI-80L, San-Aid SI-100L, San-Aid SI-1 1 OL, San-Aid SI-150L and San-Aid SI-180L from Sanshin Chemical, SarCat CD-1010, SarCat CD-1011 and SarCat CD-1012 from Sartomer, Degacure K185 from Degussa, Rhodorsil Photoinitiator 2074 from Rhodia, CI-2481, CI-2624, CI-2639, CI-2064, CI-2734, CI-2855, CI-2823 and CI-2758 from Nippon Soda, Omnicat 320, Omnicat 430, Omnicat 432, Omnicat 440, Omnicat 445, Omnicat 550, Omnicat 550 BL and Omnicat 650 from IGM Resins, Daicat II from Daicel, UVAC 1591 from Daicel-Cytec, FFC 509 from 3M, BBI-102, BBI-103, BBI-105, BBI-106, BBI-109, BBI-110, BBI-201, BBI-301, BI-105, DPI-105, DPI-106, DPI-109, DPI-201, DTS-102, DTS-103, DTS-105, NDS-103, NDS-105, NDS-155, NDS-159, NDS-165, TPS-102, TPS-103, TPS-105, TPS-106, TPS-109, TPS-1000, MDS-103, MDS-105, MDS-109, MDS-205, MPI-103, MPI-105, MPI-106, MPI-109, DS-100, DS-101, MBZ-101, MBZ-201, MBZ-301, NAI-100, NAI-101, NAI-105, NAI-106, NAI-109, NAI-1002, NAI-1003, NAI-1004, NB-101, NB-201, NDI-101, NDI-105, NDI-106, NDI-109, PAI-01, PAI-101, PAI-106, PAI-1001, PI-105, PI-106, PI-109, PYR-100, SI-101, SI-105, SI-106 and SI-109 from Midori Kagaku, Kayacure PCI-204, Kayacure PCI-205, Kayacure PCI-615, Kayacure PCI-625, Kayarad 220 and Kayarad 620, PCI-061 T, PCI-062T, PCI-020T, PCI-022T from Nippon Kayaku, TS-01 and TS-91 from Sanwa Chemical, Deuteron UV 1240 from Deuteron, Tego Photocompound 1465N from Evonik, UV 9380 C-D1 from GE Bayer Silicones, FX 512 from Cytec, Silicolease UV Cata 21 1 from Bluestar Silicones and Irgacure 250, Irgacure 261, Irgacure 270, Irgacure PAG 103, Irgacure PAG 121, Irgacure PAG 203, Irgacure PAG 290, Irgacure CGI 725, Irgacure CGI 1380, Irgacure CGI 1907 and Irgacure GSID 26-1 from BASF. Photo acid generators are used uncombined or as a combination of two more photo acid generators.

According to one particularly preferred embodiment, the photo acid generator comprises a compound whose anions are Tetrakis(pentafluorophenyl)borate.

The fraction of (D) in the adhesive is preferably at least 0.1 wt % to at most 10.0 wt %, more preferably 1 wt % to 5.5 wt %, more preferably 1.5 wt % to 4.0 wt %, more preferably 2.0 wt % to 3.0 wt %.

Matrix Polymer (E)

Suitable optional matrix polymers as film former for adhesives of the invention are thermoplastic materials, elastomers and thermoplastic elastomers. They are selected more particularly such that in combination with the other formulation constituents, they enable access to adhesives which are advantageous in terms of production, further processing and handling of latent reactive adhesive films. This relates to processing operations at the adhesive tape manufacturer on the one hand and adhesive tape user on the other hand, in terms of technical adhesive properties and in terms of further improvement in the dimensional stability of the films, in relation to the presentation of the adhesive product and the oozing behavior in the hot lamination process, to name just a few particularly important requirements.

In advantageous procedures, thermoplastic materials used as matrix polymers (E) are different from the (co)polymer (A) and/or epoxide-containing compounds (B). Examples are semicrystalline polyolefins and ethylene-vinyl acetate copolymers (EVA). Preferred polyolefins are prepared from ethylene, propylene, butylene and/or hexylene, in which case respectively the pure monomers can be polymerized or mixtures of the stated monomers are copolymerized. Through the polymerization process and through the selection of the monomers it is possible to direct the physical and mechanical properties of the polymer, such as the softening temperature and/or specific mechanical properties, for example.

Elastomers can be employed very advantageously as matrix polymers (E). Examples include rubber or synthetic rubber as a starting material for the adhesive. There are diverse possibilities for variation here, whether for rubbers from the group of the natural rubbers or the synthetic rubbers, or from any desired blend of natural rubbers and/or synthetic rubbers—the natural rubber or rubbers may be selected in principle from all available grades such as, for example, Crepe, RSS, ADS, TSR or CV varieties, depending on required level purity and of viscosity, and the synthetic rubber or rubbers may be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), EPDM, the polybutylenes or the polyisobutylene. Elastomers may also be in (partially) hydrogenated form.

Very advantageous are nitrile rubbers, especially those polymerized hot, and those having an acrylonitrile content of between 15% and 50%, preferably between 30% and 45%, and also a Mooney viscosity (ML 1+4, 100° C.) of between 30 and 110, preferably between 60 and 90.

Also very advantageous are poly(meth)acrylates which are composed of the above-described (co)monomers (b), (c) and/or (d) and have a weight-average molar mass of typically at least 100 000 g/mol and typically at most 5 000 000 g/mol, more particularly of at least 250 000 g/mol and at most 2 000 000 g/mol. The glass transition temperature of these poly(meth)acrylates may be in particular below 25° C. or even below 0° C., and more particularly below −25° C. This allows access to tacky reactive adhesive systems.

Likewise advantageous are thermoplastic elastomers, including, in particular, block, star and/or graft copolymers having a molar mass Mw (weight average) of 300 000 g/mol or less, preferably 200 000 g/mol or less. Lower molar weights are preferred here on account of their better processing properties. The molar mass ought not to be below 50 000 g/mol.

Specific examples are styrene-butadiene block copolymers (SBS), styrene-isoprene block copolymers (SIS), styrene-(isoprene/butadiene) block copolymers (SIBS) and (partially) hydrogenated variants such as styrene-(ethylene/butylene) block copolymers (SEBS), styrene-(ethylene/propylene) block copolymers (SEPS, SEEPS), styrene-(butylene/butyl) block copolymers (SBBS), styrene-isobutylene block copolymers (SiBS) and polymethyl methacrylate-polyacrylate block copolymers. These block copolymers may be used in the form of a linear or multiarm structure, as diblock copolymer, triblock copolymer or multiblock copolymer, and also as mixtures of different types.

Further advantageous examples of thermoplastic elastomers are thermoplastic polyurethanes (TPUs). Polyurethanes are chemically and/or physically crosslinked polycondensates which are typically constructed from polyols and isocyanates and typically comprise soft and hard segments. The soft segments consist, for example, of polyesters, polyethers, polycarbonates—preferably in each case aliphatic in nature for purposes of this invention—and polyisocyanate half segments. Depending on the nature of the individual components and the ratio in which they are used, materials are obtainable which can be employed advantageously for the purposes of this invention. Raw materials available to the formulator for this purpose are identified for example in EP 894 841 B1 and EP 1 308 492 B1. Particular preference is given to using semicrystalline (partially crystalline) thermoplastic polyurethanes.

Further possibilities for use for matrix polymers (E) are polyolefin-based thermoplastic elastomers, polyetherester elastomers. Suitable saturated thermoplastic polymers may likewise be advantageously selected from the group of the polyolefins (for example, ethylene-vinyl acetate copolymers (EVA)), the polyethers, the copolyethers, the polyesters, the copolyesters, the polyamides, the copolyamides, the polyacrylic esters, the acrylic ester copolymers, the polymethacrylic esters, the methacrylic ester copolymers, and also chemically or physically crosslinked substances among the aforesaid compounds. It is also possible, furthermore, to use blends of different thermoplastic polymers, especially from the classes of compound above. Particular preference is given to using semicrystalline (partially crystalline) thermoplastic polymers.

Preferred examples are polyolefins, especially semicrystalline polyolefins. Preferred polyolefins are prepared from ethylene, propylene, butylene and/or hexylene, and in each case the pure monomers may be polymerized or mixtures of stated monomers are copolymerized. Through the polymerization process and through the selection of the monomers it is possible to direct the physical and mechanical properties of the polymer, such as the softening temperature and/or specific mechanical properties, for example.

Use may preferably be made as thermoplastic polymers of thermoplastic elastomers, either alone or else in combination with one or more thermoplastic polymers from the classes of compound already stated above. Particular preference is given to using saturated semicrystalline thermoplastic elastomers.

Particularly preferred are thermoplastic polymers having softening temperatures of less than 100° C. The term “softening point” in this context stands for the temperature above which the thermoplastic pellets stick to themselves. When the polymers in question are semicrystalline thermoplastic polymers, the polymer advantageously has not only its softening temperature—in particular as characterized above—(and coinciding with the melting of the crystallites) but also a glass transition temperature of at most 25° C.

One preferred embodiment of the invention uses a thermoplastic polyurethane without C—C multiple bonds. The thermoplastic polyurethane preferably possesses a softening temperature of less than 100° C., more particularly less than 80° C.

A further preferred embodiment of the invention uses a mixture of two or more saturated thermoplastic polyurethanes. The mixture of the thermoplastic polyurethanes preferably possesses a softening temperature of less than 100° C., more particularly less than 80° C.

The fraction of (E) in the adhesive, if present, is preferably at least 2.0 wt % to at most 94.5 wt %, more preferably 25.0 wt % to 92.5 wt %, more preferably 50.0 wt % to 91.5 wt %, more preferably 75.0 wt % to 90.5 wt %, most preferably 80.0 to 90.0 wt %.

Additives (F)

The adhesive of the present invention may further comprise at least one additive. Particularly suitable additives are described below.

Further constituents may optionally be added to the adhesives of the invention to adjust the properties of the adhesives in accordance with requirements, in particularly as pressure sensitive adhesive, adhesive, sealing compound or sealant. Mention may be made in this context of tackifying resins (F1) preferably at up to 60 wt %, especially preferably up to 25 wt %, based on the; low-viscosity reactive resins (F2) preferably up to 15 wt %, based on the adhesive; and further additives (F3) preferably at up to 50 wt %, more preferably up to 25 wt %, very preferably up to 10 wt %, based on the adhesive.

(F1) Tackifying Resins

The adhesive of the invention optionally comprises one or more kinds of a tackifying resin, advantageously those which are compatible with the (co)polymer (A) and/or with the epoxide-containing compound (B) and/or with the matrix polymer (E).

It is advantageous if this tackifying resin has a tackifying resin softening temperature (ASTM E28) of greater than 25° C., more particularly of greater than 80° C.

As tackifying resins (F1) in the adhesive it is possible, for example, to use partially or fully hydrogenated or disproportionated resins based on rosin and rosin derivatives, indene-coumarone resins, terpene-phenolic resins, phenol resins, hydrogenated polymers of dicyclopentadiene, partially, selectively or fully hydrogenated hydrocarbon resins based on C5, C5/C9 or C9 monomer streams, polyterpene resins based on a-pinene and/or β-pinene and/or δ-limonene, hydrogenated polymers of preferably pure C8 and C9 aromatics. Aforesaid tackifying resins may be used both alone and in a mixture.

In order to ensure high ageing stability and UV stability, preference is given to hydrogenated resins having a degree of hydrogenation of at least 90%, preferably of at least 95%.

The skilled person selects suitable tackifying resins in accordance with relevantly known procedures from the sector of the pressure sensitive adhesives, for resin/polymer compatibility. The skilled worker makes use in particular of the concept of selection by way of the cloud points DACP (diacetone alcohol cloud point) and MMAP (mixed methylcylohexane aniline point). The DACP and the MMAP each indicate solubility in a particular solvent mixture. For the definition and determination of the DACP and MMAP, reference may be made to C. Donker, PSTC Annual Technical Proceedings, pp. 149-164, May 2001.

(F2) Reactive Resins of Low Molecular Mass

Optionally but advantageously it is possible to use reactive resins of low molecular mass which are different from the epoxide-containing compound (B). They preferably have a softening temperature (more particularly glass transition temperature) of below room temperature. Their weight-average molar mass is preferably less than 5000 g/mol, more preferably less than 1000 g/mol. They are employed in the adhesive in a fraction preferably of at most 25 wt %, very preferably of at most 10 wt %. These low-viscosity reactive resins are, in particular, cyclic ether, i.e. compounds which carry at least one oxirane group, or oxetanes. They may be aromatic or especially aliphatic or cycloaliphatic in nature. Reactive resins which can be used may be monofunctional, difunctional, trifunctional, tetrafunctional or of higher functionality up to polyfunctional in form, the functionality referring to the cyclic ether group.

Examples, without pushing to impose any limitation, are 3,4-epoxycyclohexylmethyl 3′,4′-epoxycyclohexancarboxylate (EEC) and derivates, dicyclopentadiene dioxide and derivates, 3-ethyl-3-oxetanemethanol and derivates, bis[(3,4-epoxycyclohexyl)methyl]adipate and derivates, vinylcyclohexyl dioxide and derivates, 1,4-cyclohexanedimethanol bis(3,4-epoxycyclohexancarboxylate) and derivates, bis[1-ethyl(3-oxetanyl)methyl) ether and derivates, 2-(7-oxabicyclospiro(1,3-dioxan-5,3′-(7-oxabicyclo[4.1.0]-heptane))), 1,4-bis((2,3-epoxypropoxy)methyl)cyclohexane. Here as well (cyclo)aliphatic epoxides are preferred.

Reactive resins may be used in their monomeric or else dimeric or trimeric form and so on, up to their oligomeric form, provided the weight-average molecular weight does not reach or exceed 5 000 g/mol.

Because these reactive resins are typically of low viscosity, they harbor the risk of a too high fraction thereof in an adhesive leading to a too high oozing tendency. The fraction used in the adhesive is therefore as low as possible, preferably at most 25 wt %, very preferably at most 10 wt %. Up to 50 wt % may be used only when the fraction of (co)polymer (A) is at least 50 wt % and the sum total of the fractions of (co)monomers (a) and optionally (b) in the (co)polymer (A) is at least 50 wt %.

Mixtures of reactive resins with one another or else with other co-reactive compounds such as alcohols (monofunctional or multiply functional) or vinyl ethers (monofunctional or multiply functional) are likewise possible.

Particularly suitable co-reactive compounds are alcohols such as monools, diols, triols or polyols of higher functionality.

As adhesion promoters it is likewise possible advantageously to use silane adhesion promoters. Silane adhesive promoters utilized are, in particular, compounds of the general form RR′ₐR″_{b}SiX_{(3-a-b)}, where R, R′ and R″ are selected independently of one another and each denote a hydrogen atom bonded to the Si atom, or an organic functionalized radical bonded to the Si atom, X denotes a hydrolyzable group, a and b are each 0 or 1, and where R, R′ and R″ or two representatives of this group may also be identical.

As adhesion promoters it is also possible to utilize compounds for which two or more hydrolyzable groups X, when present, are not identical, but instead differ from one another [corresponding to the formula RR′ₐR″_{b}SiXX′_{c}X″_{d}, with X, X′ and X″ as hydrolyzable groups selected independently of one another (of which in turn, however, two may also be identical), c and d are each 0 or 1, with the proviso that a+b+c+d=2].

Hydrolyzable groups utilized are, in particular, alkoxy groups, and so alkoxysilanes in particular are used as adhesion promoters. The alkoxy groups of a silane molecule are preferably the same, but in principle they may also be selected differently.

Alkoxy groups selected are, for example, methoxy groups and/or ethoxy groups. Methoxy groups are more reactive than ethoxy groups. Methoxy groups may therefore exhibit a better effect at promoting adhesion, as a result of faster reaction with the substrate surfaces, and the amount used may therefore optionally be reduced. Ethoxy groups, on the other hand, have the advantage that because of the lower reactivity they have less of an (possibly negative) effect on the working time and/or the shelf life of the adhesive film, not least in relation to the desired heat-and-humidity stability.

Adhesion promoters used are preferably trialkoxysilanes R—SiX₃. Examples of trialkoxysilanes suitable in accordance with the invention are

Trimethoxysilanes—such as N-(2-aminoethyl)-3-aminopropyl trimethoxysilane, N-cyclohexyl-3-aminopropyl trimethoxysilane, 3-aminopropyl trimethoxysilane, 3-ureidopropyl trimethoxysilane, vinyltrimethoxysilane, 3-glycidyloxypropyl trimethoxysilane, 3-methacryloxypropyl trimethoxysilane, methacryloxymethyl trimethoxysilane, N-methyl-[3-(trimethoxysilyl)propyl]carbamate, N-trimethoxysilylmethyl-O-methylcarbamate, tris[3-(trimethoxysilyl)propyl] isocyanurate, 3-glycidyloxypropyl trimethoxysilane, methyltrimethoxysilane, isooctyltrimethoxysilane, hexadecyltrimethoxysilane, 3-mercaptopropyl trimethoxysilane, 3-aminopropyl trimethoxysilane, N-(2-aminoethyl)-3-aminopropyl trimethoxysilane, N-phenyl-3-aminopropyl trimethoxysilane, N-ethyl-3-aminoisobutyl trimethoxysilane, bis[3-(trimethoxysilyl)propyl]amine, 3-isocyanatopropyl trimethoxysilane, 2-(3,4-epoxycyclohexyl)-ethyl-trimethoxysilane; 3-methacryloxypropyl trimethoxysilane, 3-methacrylamidopropyl trimethoxysilane, p-styryltrimethoxysilan, 3-acryloxypropyl trimethoxysilane, N-(vinylbenzyl)-2-aminoethyl-3-aminopropyltrimethoxysilane hydrochloride, triethoxysilanes—such as N-cyclohexyl-aminopropyl triethoxysilane, 3-aminopropyl triethoxysilane, 3-ureidopropyl triethoxysilane, 3-(2-aminomethyl-amino)propyl triethoxysilane, vinyltriethoxysilane, 3-glycidyloxypropyl triethoxysilane, methyltriethoxysilane, octyltriethoxysilane, isooctyltriethoxysilane, phenyltriethoxysilane, 1,2-bis(triethoxysilan)ethane, 3-octanonylthio-1-propyl-triethoxysilane; 3-aminopropyl-triethoxysilane, bis-[3-(triethoxysilyl)propyl]amine, 3-isocyanatopropyl-triethoxysilane, 2-(3,4-epoxycyclohexyl)-ethyl-triethoxysilane, 3-methacryloxypropyl-triethoxysilane, 3-methacrylamidopropyl-triethoxysilane, 3-triethoxysilyl-N-(1,3-dimethylbutadiene)propylamide, triacetoxysilanes—such as vinyltriacetoxysilane, 3-methacryloxypropyl triacetoxysilane, triacetoxyethylsilane mixed trialkoxysilanes—such as 3-methacrylamidopropyl-methoxy-diethoxysilane, 3-methacryl-amidopropyl-dimethoxy-ethoxysilane.

Examples of dialkoxysilanes suitable in accordance with the invention are Dimethoxysilanes—such as N-(2-aminoethyl)-3-aminopropyl-methyldimethoxysilane, vinyldimethoxy-methylsilane, (methacryloxymethyl)-methyldimethoxysilane, methacryloxymethyl-methyl-dimethoxysilane, 3-methacryloxypropyl-methyldimethoxysilane, dimethyldimethoxysilane, (cyclohexyl)methyldimethoxysilane, dicyclopentyl-dimethoxysilane, 3-glycidyloxypropyl-methyldimethoxysilane, 3-mercaptopropyl-methyldimethoxysilane diethoxysilanes—such as dimethyldiethoxysilane, gamma-aminopropylmethyldiethoxysilane; 3-glycidoxypropylmethyldiethoxysilane, 3-methacryloxypropylmethyldiethoxysilane.

One example of a monooxysilane is trimethyloxysilane.

The amount of adhesion promoters added may be selected in principle within a wide range, according to the desired properties of the product and with account being taken of the raw materials selected for the adhesive films. It has emerged, however, as being very advantageous in accordance with the invention if the amount of adhesion promoter used, based on the adhesive used, is selected in the range from 0.5 to 20 wt %, preferably in the range from 1 to 10 wt %, more preferably from 1.5 to 5 wt %, very preferably in the range from 2.5 to 3.5 wt %.

Very large amounts of adhesion promoters used may have a strongly plasticizing effect, and so, in particular with regard to films of sufficient stability, it may be advantageous to select as small as possible an amount of adhesion promoter, so that while, on the one hand, the desired positive effect on the heat-and-humidity resistance is sufficiently great, the properties of the adhesive film in terms of its dimensional integrity and stability, on the other hand, are not too adversely affected.

As further optional constituents (F) it is possible as additives to the adhesives to add customary additives (F3) such as ageing inhibitors, such as antiozonants, antioxidants and light stabilizers.

Possible optional additives (F3) to the adhesive include the following:

primary antioxidants such as, for example, sterically hindered phenols
secondary antioxidants such as, for example, phosphites or thioethers
process stabilizers such as, for example, C-radical scavengers
light stabilizers such as, for example, UV absorber or sterically hindered amines
processing assistants such as rheological additives (e.g., thickeners)
wetting additives
expandants such as chemical foaming agents and/or expanded or expandable microballoons and/or hollow spheres such as hollow glass spheres
adhesion promoters
compatibilizers
colorants/pigments
fillers/functionalized fillers

This listing should not be viewed as exhaustive or imposing any limitation.

The adhesive advantageously further comprises one or more plasticizers. Examples thereof that are used are plasticizers based on aliphatic or cycloaliphatic alkyl esters. The esters are preferably esters of aliphatic or cycloaliphatic carboxylic acids, especially dicarboxylic acid. Use may also be made, however, of phosphoric esters (phosphates). Among the aliphatic carboxylic esters, examples include alkyl or cycloalkyl adipates such as, in particular, di-(2-ethylhexyl) adipate, diisononyl adipate, diisodecyl adipate, ditridecyl adipate and dioctyl adipate. Further examples are alkyl and cycloalkyl sebacates such as, in particular, di-(2-ethylhexyl) sebacate, and alkyl and cycloalkyl azelates such as, in particular, di-(2-ethylhexyl) azelate. Particularly preferred for use are aliphatic or cycloaliphatic cyclohexyldicarboxylic diesters, as described for example in WO 2011/009672 A1, especially 1,2-diisobutylcyclohexanedicarboxylic esters, 1,2-di-(2-ethylhexyl)cyclohexanedicarboxylic esters or 1,2-diisononylcyclohexanedicarboxylic esters (also referred to as “DINCH”). Selected representatives of this group are available for example from BASF SE. As for the selection of tackifying resins, the optionally employable plasticizers are also selected with an eye to compatibility with other constituents of the adhesive, especially with (co)polymers (A) and/or epoxide-containing compounds (B) and/or—if present—matrix polymers (E).

The additives are not mandatory, an advantage of the adhesive of the invention is that it has its advantageous properties even without the addition of additional additives individually or in any desired combination. In certain cases, nevertheless, it may be advantageous and desirable to adjust certain further properties of the adhesive, particularly of the customary adhesives, pressure sensitive adhesives or sealants, through addition of additives.

For example, the transparency of the composition and its color can be influenced. Some formulations are made optically clear, others opaque, still others colored, black, white or grey.

Selection among the optional additives as well is made preferably of those which prior to the initiation of the curing reaction do not enter into substantially any reaction, and more particularly no reaction at all, with glycidyl or epoxide functionalities, or which neither initiate nor catalyze the reactions of the glycidyl or epoxide functionalities, or of those for which the reaction with glycidyl or epoxide functionalities is otherwise prohibited.

In combination with optionally employable comonomers (d) based on silane, if such are employed, or else alternatively it is possible as adhesion promoters to use further silanes which are not incorporated by polymerization into the functionalized (co)polymers (A) of the invention. Examples of silanes which can be used in the sense of this invention, without wishing to impose any limitation, are methyltrimethoxysilane, methyltriethoxysilane, dimethyldimethoxysilane, dimethyldiethoxysilane, trimethylethoxysilane, ethyltrimethoxysilane, propyltrimethoxysilane, propyltriethoxysilane, isobutyltrimethoxysilane, isobutyltriethoxysilane, octyltrimethoxysilane, octyltriethoxysilane, isooctyltrimethoxysilane, isooctyltriethoxysilane, hexadecyltrimethoxysilane, hexadecyltriethoxysilane, octadecylmethyldimethoxysilane, phenyltrimethoxysilane, phenyltriethoxysilane, cyclohexylmethyldimethoxysilane, dicyclopentyldimethoxysilane.

One example of silyl-functionalized oligomers or polymers which may be employed in accordance with the invention is polyethylene glycol linked to a trimethoxysilane group.

Further examples of silanes which can be used and which carry at least one functionalization are vinyltrimethoxysilane, vinyltriethoxysilane, vinyltri(2-methoxyethoxy)silane, vinyltriisopropoxysilane, vinyldimethoxymethylsilane, vinyltriacetoxysilane, 3-glycidyloxypropyltrimethoxysilane, 3-glycidyloxypropyltriethoxysilane, 2-(3,4-epoxycyclohexyl)ethyltriethoxysilane, 3-glycidyloxypropyldiethoxymethylsilane, 3-methacryloyloxypropyltrimethoxysilane, 3-methacryloyloxypropyltriethoxysilane, 3-methacryloyloxypropyltriisopropoxysilane, 3-methacryloyloxypropyldimethoxymethylsilane, 3-methacryloyloxypropyldiethoxymethylsilane, 3-chloropropyltrimethoxysilane, 3-chloropropyltriethoxysilane, 3-ureidopropyltrimethoxysilane, 3-ureidopropyltriethoxysilane, 2-Hydroxy-4-(3-triethoxysilylpropoxy)benzophenone, 4-(3′-chlorodimethylsilylpropoxy)benzophenone.

Examples of optional crosslinkers include latent reactive diamines or polyfunctional amines, dicarboxylic acids or polyfunctional carboxylic acids, difunctional acid anhydrides or polyfunctional acid anhydrides, primary dithiols or polyfunctional primary thiols. Particularly advantageous in terms of latency are those co-reactants which are solid at room temperature and are not soluble in the polymer of the invention or in a mixture comprising this polymer in the unsoftened state, but are soluble in the softened state, or the two melts are miscible with one another.

Also conceivable are initiators/curing agents which are present in encapsulated and/or blocked form and are distributed in the film matrix and/or undergo deblocking under the influence of heat and are able then to lead to the reaction.

Where filler particles are employed, they may be present, in terms of their structure, preferably in spherical, rodlet-shaped or platelet-shaped form. Separated particles, often also called primary particles, are in accordance with the invention, as are aggregates formed of a plurality of primary particles. Such systems often exhibit a fractal superstructure. Where the particles are formed of crystallites, the primary particle shape is dependent on the nature of the crystal lattice. Platelet-shaped systems may also take the form of layered stacks. Fillers, if employed, are present typically at up to 50 wt %.

In one advantageous embodiment of this invention, one kind of filler is present in the adhesive substantially in the form of singular spherical particles, i.e., preferably in a range of more than 95%, more preferably more than 98%, most preferably more than 99%. The particle diameters then have values of less than 500 nm, preferably of less than 100 nm, very preferably of less than 25 nm. In a further advantageous configuration of this invention, the at least one functionalized kind of filler is present in the adhesive substantially in the form of singular, platelet-shaped particles. The layer thickness of such platelets then has values of preferably less than 10 nm and a largest diameter of preferably less than 1000 nm. In a further advantageous configuration of this invention, the at least one kind of filler is present in the adhesive substantially in the form of singular rodlet-shaped particles. In this case, these rodlets have a diameter of less than 100 nm and a length of less than 15 μm. The rodlets may also be curved and/or flexible. Within this invention, moreover, it is possible advantageously for the at least one kind of filler to be present in the adhesive in the form of primary particle aggregates. These aggregates have a radius of gyration (to be understood in analogy to the term “radius of gyration” known from polymers) of less than 1000 nm, preferably of less than 250 nm. With particular preference the filler particles used in the sense of this invention are those whose spatial extent is less than 250 nm, preferably less than 100 nm, very preferably less than 50 nm in at least one direction. It is also possible in the sense of this invention to employ combinations of the aforesaid types of filler.

Typical and further classes of compound advantageous in accordance with the invention for fillers are inorganic semimetal oxides, silicate-based minerals, especially clay minerals and clays. The amorphous or crystalline metal oxides which can be used in the invention include, in particular, silicon dioxide. The skilled person is aware of further systems which may likewise be used in the invention. Carbonates, sulfates, hydroxides, phosphate and hydrogen phosphates are conceivable. The clay minerals and clays which can be used in the invention include, in particular, silicatic systems such as serpentines, kaolins, talc, pyrophyllite, smectites such as, in particular, montmorillonite, vermiculites, illites, micas, brittle micas, chlorites, sepiolite and palygorskite. It is also possible to use synthetic clay minerals such as hectorites and also systems related to them such as, for example, Laponite® from Laporte, and fluorohectorites and also systems relating to them, such as, for example, Somasif® from Co-Op in accordance with the invention.

Filler particles may on their surface be functionalized, or may be hydrophobic or hydrophilic. Particularly advantageous is functionalization by means of compounds having glycidyl groups and/or aliphatic epoxide groups which are able to participate in the curing reaction.

The fillers are not mandatory, the adhesive also functions without these fillers having been added individually or in any desired combination. Selection among the optional fillers as well is made preferably of those which prior to the initiation of the curing reaction do not enter into substantially any reaction, and more particularly no reaction at all, with glycidyl or epoxide functionalities, or which neither initiate nor catalyze the reactions of the glycidyl or epoxide functionalities, or of those for which the reaction with glycidyl or epoxide functionalities is otherwise prohibited.

The adhesive films of the invention have emerged as being outstandingly amenable to prelamination and amenable to activation in the hot injection step to form the ultimate bond strength, meaning that they have the capacity for chemical reactions, in particular for a rapid crosslinking and/or curing reaction, after appropriate activation. Activation is accomplished, in particular, thermally, in other words by supply of heat. In principle, however, other methods of activation are also known for latent reactive adhesive tapes, such as, for example, by injection, by microwaves, by irradiation with UV radiation, by laser treatment and by plasma treatment. For the purposes of the present invention, however, activation takes place by means of thermal supply of energy, and the other methods of activation may be used in particular and optionally as supplementary (additive).

During the supply of heat, the adhesive melts and is able to wet the substrate surfaces to be bonded outstandingly, and the crosslinking and/or curing reaction results in an increase in cohesion of the adhesive.

As a result of the reactive bonding, therefore, the adhesive films of the invention are capable of generating high bonding strengths to the substrates on which they are bonded. The bonding strengths here may take on orders of magnitude, for example, which exceed by a factor of ten or more the bonding strengths of customary pressure sensitive adhesives (typically <1.0 MPa in the push-out test).

The adhesives used in the invention and the corresponding adhesive films have latent reactivity. Latent reactivity in the sense of this invention refers to those activatable adhesive systems which without activation can be stored stably over prolonged periods. Latent reactive adhesive films are preferably those which under standard conditions (23° C. [296.15 K]; 50% rh) and especially at elevated storage temperatures (in particular up to 40° C. [316.15 K]) do not cure or cure only over a period of several weeks, preferably months, and are therefore storage-stable, but which at higher temperatures can be activated, and undergo curing and/or crosslinking. The latent reactivity offers the advantage that these adhesive films can be stored, transported and further processed (converted, for example) under stand conditions and advantageously particularly at elevated temperatures of up to 40° C., before they are then employed at the bonding site and cured.

During the storage time, the adhesives are not to undergo significant alteration, so that the bonding properties of an adhesive system employed for bonding freshly after production, and those of an adhesive system employed after long storage for the otherwise comparable bonding, exhibit no substantial differences from one another, but at least still meet the profile of requirements (Push-Out>1.5 MPa), still having preferably at least 50%, more preferably at least 75% and very preferably at least 90% of the performance of the unstored adhesive film.

The compositions of the invention are distinguished by the fact that on the one hand they have latent reactivity and on the other hand are curable rapidly at elevated temperature.

In one preferred version of the invention, the adhesive is admixed with at least one bonding-reinforcing additive—also referred to as adhesion promoter. Adhesion promoters are substances which enhance the force of attachment of the adhesive film on the substrate where bonding is to take place. This may be accomplished in particular through an increase in the wettability of the substrate surfaces and/or through the formation of chemical bonds between the substrate surface and the adhesive and/or components of the adhesive. Advantageous adhesion promoters have been described above under (F)

Adhesive Films

The adhesive of the invention is an adhesive film or is part—alongside one or more further layers—of an adhesive film. The invention therefore also embraces adhesive films composed of the adhesive of the invention, and adhesive films comprising a layer of the adhesive of the invention.

The adhesive films of the invention may have a single-layer construction—that is, be constructed solely of the layer of the parent adhesive—or else a multilayer construction, having been provided, for instance, with a reinforcing layer and/or carrier layer. Single-layer systems are advantageous, referred to as adhesive transfer tapes.

As carriers it is possible in principle to utilize all layers of materials suitable for this purpose to the skilled person, according to the desired properties of the product and stability on thermal activation. Hence it is possible, for example, to use carrier materials such as textile materials, woven fabrics, nonwovens, papers, polymeric films, such as, for example, mono- or biaxially drawn, optionally oriented polyolefins, polyvinyl chloride films (PVC), polypropylene films, polyethylene (PE) films, such as HDPE, (LDPE), polyethylene terephthalate films (PET), polylactide films, and also foams and woven fabrics. Carrier materials may have high or low stretchability and/or flexibility and may be selected to be tear-resistant or easily tearable, for example. Carriers utilized may likewise in principle be suitable—in particular cohesive—rubber films or layers of adhesive, such as pressure sensitive adhesives or activatable adhesives, for instance, which contribute a corresponding intrinsic stability and which satisfy the requirements in terms of the bonding conditions of the adhesive films.

The adhesive films may be lined on one or both sides with a protective liner material, known as liners. Liners serve for temporary protection and for aiding the handling of the adhesive tape and are removed again for application. In the sense of the present invention, such liners are considered to be processing aids, but not an actual part of the adhesive films of the invention. Liners may be paper or film materials which have been furnished, at least on the side facing the adhesive film of the invention, with a suitable release agent known to the skilled person. They may also be paper or film materials which have been made slightly tacky (referred to as tacky liners).

In accordance with the invention it is also possible to offer laminated adhesive tapes, these being adhesive tapes comprising a plurality of adhesive layers arranged one atop another. Laminates are advantageous, for example, when the intention is to produce relatively thick, carrier-free adhesive tapes by simple processes, since it is generally easier to produce thin adhesive layers and then to laminate them to one another than to coat adhesive layers of the resulting overall thickness directly to form a uniform, homogeneous product.

Adhesive layers, adhesive transfer tapes and laminated adhesive tapes of the invention may be configured in versions ranging from very thin—in the region of a few micrometers—through to very thick layers—in the region of several centimeters. Accordingly, multilayer adhesive tapes—including, in particular, those which comprise further layers as well as the adhesive layers—may vary in their thickness, dictated by the respective thickness of the adhesive layers—as described above—and of the further layers used, such as carrier layers, pressure sensitive adhesives, functional layers (e.g.: thermally and/or electrically conducting or insulating layers), primer layers and the like.

Typical layer thicknesses for single-layer adhesive films of the invention are in the range from 1 to 500 μm, as for example 5, 20, 25, 50, 75, 100, 125, 150, 175 or 200 μm.

The adhesive films of the invention are self-supporting and therefore self-contained products, allowing them to be readily stored, transported and applied. This differentiates them significantly form “adhesive films” made from liquid adhesives, i.e., layers of adhesive which exist only after application to the particular bond substrate and are solidified there—as part of their application in the course of use—but are not removed again from the substrate as a self-contained product. Accordingly, for instance, adhesive films of the invention can be wound up to form a roll or else offered as sections, punched shapes or what are called die-cuts. Accordingly, any cut shapes and die-cuts of adhesive films of the invention are also a subject of the invention. Another advantage of the adhesive films of the invention relative to filmlike applications of liquid adhesives is that during application and the curing reaction, they have an intrinsic dimensional stability and do not have to be fastened during the curing reaction like filmlike applications of liquid adhesives.

The effective bonding by means of the adhesive films involving their activation implies an interaction of temperature, time (cycle type); the lower the level selected for one of the parameters, the higher it is possible or necessary to select another parameter. With higher temperatures, for instance, lower cycle times are possible. If a cycle time can be made longer, then it is possible to operate at a lower temperature.

The compression pressure in this context constitutes primarily an operational parameter and is dependent on the raw materials used for the formulation, in combination with the cycle time. By means of increased pressure, it is thus possible to promote flow onto the substrates and also the wetting of the substrates in the case of formulations with an enhanced melt viscosity, in combination with short cycle times. In the case of formulations with a lower melt viscosity, especially in combination with relatively long cycle times, a lower pressure may be advantageous, in order to prevent unwanted oozing of the adhesive from the bondline. For the advantageous formulations of the invention ascertained here, for example, it has been possible advantageously to operate with a pressing pressure of 10 bar, although the invention is not confined to this pressing pressure.

The contact time during activation of the adhesive film (the activation time) may in particular be reduced considerably by options for varying the other parameters within the parameter limits still available, which are dictated by the stability of the substrates where bonding is to take place.

In principle, the maximum permissible temperature is determined by the substrates to be bonded. For many of the target applications (for instance, the bonding of plastics and/or anodized substrates), the temperature selected ought not to be higher than 200° C., in order not to damage the substrates. The fundamental rule is here that the higher the temperature selected, the shorter should be the cycle time, in order to expose the substrates to the minimum damaging influence of heat. With the invention it has been possible to reduce the cycle time to less than 10 s at a temperature of 200° C., and to 10 s at 190° C. (10 bar pressure in each case). At temperatures below 170° C., in contrast, maximum cycle times of up to one minute, advantageously up to 30 s, may be acceptable. Generally speaking, a cycle time as short as possible with a maximum possible temperature, depending on the sensitivity of the substrates to be joined, is advantageous in order to increase productivity in the processing operation.

The adhesive films of the invention are readily storable, without losing their positive properties as adhesive films. The adhesives are not to change significantly during the storage time, so that the bonding properties of an adhesive system used for bonding freshly after production are not substantially different from those of an adhesive system employed for the otherwise comparable bonding after prolonged storage, advantageously, in particular, at increased storage temperatures of 40° C., with the former adhesive system nevertheless preferably still at least meeting the profile of requirements (push-out>1.5 MPa), and more preferably still having at least 50%, very preferably at least 75%, especially preferably at least 90% of the performance of the unstored adhesive film.

The heat-and-humidity resistance may be optimized further by adding one or more adhesion promoters to the adhesive utilized for producing the latent reactive adhesive film of the invention. As adhesion promoters here it is possible to use substances which improve the adhesion of the adhesive film to the substrate surface.

The test known as the push-out test in particular is regarded as a quantitative criterion of the bonding properties of an adhesive film. For the push-out test, a substrate in disk form with an adhesive film sample is bonded to a second, frame-shaped substrate and a determination is then made of the force which has to be applied in order to separate the two substrates from one another again (in this regard, compare the deeper details in the experimental section, test method A).

The adhesive films of the invention preferentially have a good bond strength. The bond strength is quantified by the result of the push-out test. The adhesive films of the invention as a fresh sample (freshly coated adhesive film after drying for 30 min at 70° C. in a suitable forced-air drying cabinet and subsequent 24 h conditioning under standard conditions (23° C./50% rh) preferably have a push-out value in the push-out test (measurement of force for parting a bonded assembly composed of a polycarbonate disk (Makrolon 099) with a frame of anodized aluminum (E6EV1) by means of a layer of the adhesive film under investigation with a thickness of 100 μm for an effective bond area of 282 mm² [for deeper details, compare also Tests A and B] of at least 1.5 MPa, preferably of at least 2.5 MPa, very preferably of at least 3.5 MPa or even higher, and preferably after bonding under the following bonding conditions I, more preferably also under the following bonding conditions II, and even more preferably still under the following bonding conditions III:
I. Preliminary lamination 70° C., 15 s; final bonding (pressing conditions) 190° C., 10 s; 10 bar; conditioning of the bonded assembly for 24 h at 23° C./50% rh [rh stands for relative humidity]; testing in each case at 23° C., 50% rh
II. Preliminary lamination 70° C., 15 s; final bonding (pressing conditions) 180° C., 12 s; 10 bar; conditioning of the bonded assembly for 24 h at 23° C./50% rh; testing in each case at 23° C., 50% rh
III. Preliminary lamination 70° C., 15 s; final bonding (pressing conditions) 170° C., 30 s; 10 bar; conditioning of the bonded assembly for 24 h at 23° C./50% rh; testing in each case at 23° C., 50% rh

These pressing conditions are dependent on the radical initiator used and should in no way be understood as imposing any limitation. Hence shorter and/or longer pressing times and/or lower and/or higher pressing temperatures may also be advantageous.

In a way which is additionally very preferred, moreover, the adhesive films of the invention exhibit good heat-and-humidity resistance. In order to quantify the heat-and-humidity resistance, it is likewise possible to employ the push-out test, specifically after defined storage (72 h at 85° C. and 85% rh) of the adhesive assembly under investigation, produced using the adhesive film of the invention. The details of this test are described in detail in the experimental section.

The adhesive films of the invention advantageously have a push-out value in the push-out test even after heat-and-humidity storage (measurement of force for the parting of a bonded assembly composed of a polycarbonate disk (Makrolon 099) with a frame of anodized aluminum (E6EV1) by means of a layer of the adhesive film under investigation of 100 μm thickness with an effective bond area of 282 mm² of at least 1.5 MPa, preferably of at least 2.5 MPa, very preferably of at least 3.5 MPa or even higher, and preferably in all three cases after bonding under the above-stated bonding conditions I, and III.

These pressing conditions are dependent on the radical initiator used and should in no way be understood as imposing any limitation. Hence shorter and/or longer pressing times and/or lower and/or higher pressure temperatures may also be advantageous.

Preferably, moreover—in combination with the above-stated minimum values—the bond strength—in the sense of the above-stated push-out force value—of the bonded assembly after heat-and-humidity storage ought to be more than 50% of that of the bonded assembly which has not undergone heat-and-humidity storage; more preferably, the bond strength of the bonded assembly which has undergone heat-and-humidity storage ought to be more than 75% of that of the bonded assembly which has not undergone heat-and-humidity storage; and very preferably the bond strength of the bonded assembly which has undergone heat-and-humidity storage ought to be more than 90% of that of the bonded assembly which has not undergone heat-and-humidity storage, or even exceeds the value for the assembly which has not undergone heat-and-humidity storage.

Latent-reactive adhesive systems is the term used for those activatable adhesives which without activation can be stored stably for prolonged periods. Preferred latent-reactive adhesive films are those which under standard conditions (23° C. [296.15 K]; 50% rh) and advantageously in particular at higher temperatures (in particular up to 40° C. [316.15 K]) do not cure, or cure only over a period of several weeks, preferably months, and are therefore storage-stable, but which—for example at significantly higher temperatures—can be activated (in this regard, compare also the “latency” test in the experimental section) and undergo curing and/or crosslinking). The latent reactivity affords the advantage that these adhesive films can be stored, transported and further processed (converted, for example) under standard conditions and/or at elevated temperatures, in particular up to 40° C., before they are then employed and cured at the bonding site.

During storage time here, the adhesives are not—advantageously—to undergo any significant change, so that the bonding properties of an adhesive system used for bonding freshly after production are not substantially different from those of an adhesive system used for the otherwise comparable bonding after prolonged storage. The latent reactivity as well (also called latency within the text) of the adhesive films can be quantified by way of the push-out test.

In the sense of the present text, adhesive films are deemed to be latent reactive in particular when an adhesive film sample stored after at least 3 weeks, preferably at least 4 weeks at 40° C. in a standard commercial, suitable forced-air drying cabinet (drying cabinet is under standard conditions), in comparison to an otherwise identical fresh sample, exhibits detractions of not more than 25%, preferably not more than 15%, more preferably not more than 10% in the push-out test (measurement of force for the parting of an adhesive bond between a polycarbonate disk (Makrolon 099) and a frame made of anodized aluminum (E6EV1) by means of a layer of the adhesive film under investigation, with an effective bond area of 282 mm², this being the case preferably in all three cases after bonding under the above-stated bonding conditions I, II and III.

These pressing conditions are dependent on the radical initiator used and should in no way be interpreted as imposing any limitation. Hence shorter and/or longer pressing times and/or lower and/or higher pressing temperatures may also be advantageous.

With further preference the films of adhesive are also resistant in relation to their heat-and-humidity behavior, meaning that in the push-out test on the bonded assembly they exhibit—even after prolonged storage of the adhesive film, prior to production of the assembly, for at least 3 weeks, preferably at least 4 weeks at 40° C. in a standard commercial, suitable forced-air drying cabinet (drying cabinet is under standard conditions), and after further heat-and-humidity storage (72 h at 85° C. and 85% rh) and subsequent reconditioning under standard conditions (24 h at 23° C. [296.15 K]; 50% rh) of the bonded assembly produced—only allowable deviations from the corresponding values for a bonded assembly composed of correspondingly stored adhesive films, but without the assembly having undergone heat-and-humidity storage.

Heat-and-humidity resistance even for the adhesive films having undergone long-term storage exists—in line with criteria already stated above—in turn if the bond strength of the bonded assembly having undergone heat-and-humidity storage is more than 50% of that of the bonded assembly which has not undergone heat-and-humidity storage; heat-and-humidity resistance is deemed to be good if the bond strength of the bonded assembly which has undergone heat-and-humidity storage is more than 75% of that of the bonded assembly which has not undergone heat-and-humidity storage, and to very good if the value for the bond strength of the assembly which has undergone heat-and-humidity storage exceeds at least 90% of the value for the unstored sample.

The determination of the bond strength here corresponds to the aforementioned push-out test.

The adhesive films of the invention are suitable in principle for the bonding of all substrates, specifically both rigid and flexible materials. The substrates to be bonded may have diverse configurations, thicknesses and the like. Illustrative examples here would include glass, plastics of all kinds, metal, ceramics, textiles, fabrics of all kinds, synthetic leather, and natural substrates, the bond being in each case to the same material or else to one another.

### EXPERIMENTAL SECTION

The adhesive film samples of the invention and also the comparative samples are evaluated using the test methods set out below. These test methods represent the preferred measurement methods for the respective features described above, unless the measurement method was explicitly defined otherwise there.

Push-Out Test:

The push-out test provides information about the bond strength of an adhesive product in the direction normal to the adhesive layer. Elements provided are a circular first substrate (1) (polycarbonate, Macrolon 099, thickness 3 mm) 21 mm in diameter, a second substrate (2) (anodized aluminum, E6EV1, thickness 1.5 mm)—in square format with a 40 mm side length, for example—having a circular opening (drilled hole) in the center with a diameter of 9 mm, and the adhesive film sample under investigation, likewise converted (cut to shape or die-cut) to a circular form with a 21 mm diameter.

From the aforesaid three construction elements a test specimen is produced by carrying out preliminary lamination (at 70° C. for 15 s) of the adhesive product with the free surface onto the substrate (1) in an exact fit. The temporary carrier is then removed, and this assembly is then subjected to concentric prelamination, by the now exposed side of the adhesive product, onto the substrate 2 (likewise at 70° C. for 15 s), in other words such that the circular cut-out in the substrate 2 is located precisely centrally over the circular first substrate 1 (giving a bond area of 282 mm²). Care is taken to ensure that the total time of temperature exposure (70° C.) in the preliminary laminating operation does not exceed 30 s. Thereafter the overall assembly is compressed with exposure to temperature and pressure, forming the test specimen. The conditions of compressing are specified in the evaluation.

After having been compressed, the test specimens are stored for 24 h at 23° C. and 50% relative humidity (rh) (standard test conditions) (reconditioning).

Testing takes place as follows: a tensile testing machine is equipped with a cylindrical die (steel, diameter 7 mm) and the test specimen is clamped via substrate (2) into a mount of the tensile testing machine so that substrate (1) is held only by the adhesive bond and can be detached by parting of the bond using sufficient pressure. The sample is fastened in such a way as to minimize possible bending of substrate (2) during the test as a result of the effect of force. By means of the cylindrical die, pressure is exerted perpendicularly (that is, in parallel position to the normal vector of the adhesive product surface) and centrally onto the exposed surface of the adhesive product with a constant rate of 10 mm/s through the hole in substrate (2); the tests takes place under standard test conditions (23° C. at 50% rh).

A recording is made of the force at which the bond fails and substrate (1) is parted from substrate (2) (parting of the adhesive bond, recognizable from a sudden drop in force). The force is standardized to the bond area (N/mm² or MPa). Because of the naturally high scatter of the individual results, particularly in the case of the laboratory specimens, and as a result of the adhesive failure occurring in some cases (failure at the substrate—adhesive film interface), the arithmetic mean is calculated from three individual tests.

Heat-and-Humidity Resistance:

Test specimen preparation and testing take place as for the push-out test, but after having been compressed, the test specimens are stored for 24 h at 23° C. and 50% relative humidity (rh) (standard test conditions) and then subjected in a standing position (on one of the 40 mm long sides of the baseplate) to heat-and-humidity storage (72 h at 85° C. and 85% rh), and are reconditioned for 24 h at 23° C. and 50% rh again before testing.

If the substrate 1 slips from the substrate 2 during the heat-and-humidity storage (or if the substrates visibly slip relative to one another), the sample has failed and the heat-and-humidity resistance is not sufficient.

Heat-and-humidity resistance is present if the bond strength after reconditioning is more than 50% of the value before heat-and-humidity storage, and is good for more than 75% of the original value, and is very good if the value is at least 90% of the original value or exceeds that value.

DSC:

Differential Scanning Calorimetry (DSC) takes place according to DIN 53765 and DIN 53765:1994-03. Heating curves run with a heating rate of 10 K/min. The specimens are measured in Al crucibles with a perforated lid under a nitrogen atmosphere. The first heating curve is from −140° C. to +250° C., the second heating curve is from −140° C. to +350° C. Both heating curves are evaluated. The enthalpy is evaluated by integration of the reaction peak.

This measurement is also used for determination the glass transition temperatures, with the reporting thereof being based on the glass transformation temperature value Tg in the stated measurement method, and the melting point, the reporting of which is based on the peak maximum value TSP of the melting temperature measurement, and the softening point, the reporting of which is based on the peak maximum of decrystallization/peak minimum of crystallization (crystalline or semicrystalline systems).

GPC (Gel Permeation Chromatography):

First of all a calibration was carried out with poly(styrene) standards in the separation range of the column. Subsequently the poly(styrene) calibration was converted universally into a poly(methyl methacrylate) calibration, utilizing their known Mark Houwink coefficients a and K.

The samples were weighed out exactly, admixed with a defined volume of solvent (eluent without around 200 ppm (m/V) of toluene as internal standard), and dissolved at room temperature for 24 hours. Thereafter the solutions were filtered through a 1.0 μm disposable filter and injected using an autosampler.

Eluent: THE/0.1 vol % trifluoroacetic acid (TFA)

Pre-column: PSS-SDV, 10 μm, ID 8.0 mm×50 mm

Columns: PSS-SDV, 10 μm linear one, ID 8.0 mm×300 mm SN0032906

Pump: PSS-SECcurity 1260 HPLC pump

Flow rate: 0.5 ml/min

Sample concentration: around 0.5 g/l

Injection system: PSS-SECcurity 1260 Autosampler ALS

Injection volume: 100 μl

Temperature: 23° C.

Detector: PSS-SECcurity 1260 RID

Thereafter the molar masses M_{w} and Mₙ are determined.

Raw Materials Used

Products available commercially are used as obtainable in September 2018.

| Raw materials | Company | CAS | Type |
|---|---|---|---|
| Desmomelt 530 | Covestro AG | | Semi- |
| | | | crystalline |
| | | | TPU |
| Dicumyl peroxide | Chemikalie | 80-43-3 | Radical |
| | | | initiator |
| 3-(trimethoxysilyl)propyl | Chemikalie | 2530-85-0 | Adhesion |
| methacrylate | | | promoter |
| Deuteron UV 1242 | Deuteron | 71786-70-4 | PAG |
| | GmbH | | |
| Aktisil EM | Hoffmann | | Function- |
| | Mineral | | alized |
| | GmbH | | filler |
| Heucodur Black 9-100 | Heubach | 68186-91-4 | Black |
| | GmbH | | pigment |
| 3,4-epoxycyclo- | Chemikalie | 82428-30-6 | Monomer |
| hexylmethyl | | | |
| methacrylate | | | |
| Methyl ethyl ketone | Chemikalie | 78-93-3 | Solvent |
| (MEK) | | | |
| Epikote 828 LVEL | Momentive | 25068-38-6 | Epoxy |
| | Specialty | | resin |
| | Chemicals B.V. | | |
| Vazo 2,2-azobis(2- | Chemikalie | 13472-08-7 | Radical |
| methylbutyronitrile) | | | initiator |
| 2,2-azobis(2,4- | Chemikalie | 4419-11-8 | Radical |
| dimethylvaleronitrile) | | | initiator |
| Di-(4-tert-butylcyclohexyl) | Chemikalie | 15520-11-3 | Radical |
| peroxydicarbonate | | | initiator |

Epoxy Resin Investigated
Comparative example 1 100 wt % Epikote 828 LVEL
Comparative example 2 97.5 wt % Epikote 828 LVEL+2.5 wt % Deuteron UV 1242
Comparative example 3 95 wt % Epikote 828 LVEL+5 wt % dicumyl peroxide
Inventive example 1 92.5 wt % Epikote 828 LVEL+5 wt % dicumyl peroxide+2.5 wt % Deuteron UV 1242

The Epikote 828 LVEL was homogenized with the other reagents in each case in a suitable glass vessel with screw-top lid on a suitable roller mixer.

Polymerization of the TTA15 Homopolymer

A vacuum-rated standard 2 L glass reactor is charged with 100 g of 3,4-epoxycyclohexyl methacrylate (TTA15—JIANGSU TETRA NEW MATERIAL TECHNOLOGY CO., LTD. (CAS 82428-30-6)) and 298.5 g of MEK. The reaction mixture is rendered inert with nitrogen until absence of oxygen and then heated to a product temperature of 70° C. The polymerization reactor is evacuated at a constant product temperature of 70° C. until reflux at the condenser. The reaction is carried out isothermally at the product temperature of 70° C. When the reflux is reached, the reaction is initiated with 2 g of 2,2-azobis(2,4-dimethylvaleronitrile) (CAS 4419-11-8) in solution in 5.8 g of MEK. 1 h, 2 h and 3 h after the first initiator addition, portions of 2 g of 2,2-azobis(2,4-dimethylvaleronitrile) in solution in 5.8 g of MEK and 100 g of 3,4-epoxycyclohexyl methacrylate are added to the reaction. After 6 h and 7 h, portions of 0.6 g of di-(4-tert-butylcyclohexyl) peroxydicarbonate (CAS 15520-11-3) in solution in 11.4 g of MEK are added. 22 h after addition of the first initiator, the reaction is discontinued and the polymer solution is cooled to room temperature. The polymer obtained in this way has the following molar mass distribution as measured by gel permeation chromatography: Mw=32375 g/mol, Mn=13441 g/mol. PDI=2.4087

Epoxy Homopolymer Investigated
Comparative example 4 100 wt % TTA15 homopolymer
Comparative example 5 97.5 wt % TTA15 homopolymer+2.5 wt % Deuteron UV 1242
Comparative example 6 95 wt % TTA15 homopolymer+5 wt % dicumyl peroxide
Inventive example 2 92.5 wt % TTA15 homopolymer+5 wt % dicumyl peroxide+2.5 wt % Deuteron UV 1242

The TTA15 homopolymer solution in MEK was homogenized with the other reagents in each case in a suitable glass vessel with screw-top lid on a suitable roller mixer. The MEK was subsequently removed at room temperature in a suitable way known to the skilled person.

Latent Reactive Adhesive Film Investigated

The masterbatch is produced in a suitable solvent kneader in MEK, with the solids content (SC) of the completed masterbatch being 45 wt %.

Masterbatch Composition:

50 wt % Desmomelt 530

25 wt % Aktisil EM

25 wt % Heucodur Black 9-100

### Inventive Example 3

84.5 wt % masterbatch (dry mass)

5 wt % dicumyl peroxide

5 wt % TTA15 homopolymer (dry mass)

3 wt % 3-(trimethoxysilyl)propyl methacrylate

2.5 wt % Deuteron UV 1242

SC=40 wt % in MEK (solids content, sum total of all components minus solvent) All the components were homogenized in a suitable glass vessel with screw-top lid on a suitable roller mixer, coated out to a dry film thickness of 100 μm by a suitable coating method known to the skilled person, and dried in a suitable force-air drying cabinet at 70° C. for 30 minutes.

### Comparative Example 7 (Example E1 from DE 10 2016 207 548 A)

Example E1 from DE 10 2016 207 548 A describes a latent reactive adhesive film based on a thermal acid generator (TAG). This state of the art is distinguished, for a latent reactive adhesive film, by an outstanding profile of properties, with a very good performance and very good latency at storage temperatures up to 23° C.

The disadvantage of this state of the art lies in the significantly reduced latency at elevated storage temperatures of 40° C. and in the use of a high-priced specialty chemical (TAG).

Inventive examples 1 to 3 are in accordance with the invention, while Comparative examples 1 to 7 are examples for comparison.

### Push-Out Test after Storage (Inventive Example 33)

| | | | 1 w | | 2 w | | 3 w | | 4 w | |
|---|---|---|---|---|---|---|---|---|---|---|
| Pressing | fresh | | 40° C. | | 40° C. | | 40° C. | | 40° C. | |
| conditions | MPa | s | MPa | s | MPa | s | MPa | s | MPa | s |
| 30 s @ | 3.9 | 0.2 | 4.4 | 0.6 | 4.2 | 0.5 | 3.9 | 0.3 | 4 | 0.9 |
| 170° C. @ | | | | | | | | | | |
| 10 bar | | | | | | | | | | |
| 12 s @ | 2.6 | 0.3 | 3 | 0.5 | 3.6 | 0.3 | 2.6 | 0 | 2.8 | 0.2 |
| 180° C. @ | | | | | | | | | | |
| 10 bar | | | | | | | | | | |
| 10 s @ | 3.7 | 0.6 | 3.4 | 0.5 | 4 | 0.5 | 3.1 | 0.2 | 3.5 | 0.1 |
| 190° C. @ | | | | | | | | | | |
| 10 bar | | | | | | | | | | |

w = week,
s = standard deviation

### Heat-and-Humidity Resistance after Storage (Inventive Example 3)

| | | | 1 w | | 2 w | | 3 w | | 4 w | |
|---|---|---|---|---|---|---|---|---|---|---|
| Pressing | fresh | | 40° C. | | 40° C. | | 40° C. | | 40° C. | |
| conditions | MPa | s | MPa | s | MPa | s | MPa | s | MPa | s |
| 30 s @ | 2.9 | 0.3 | 2.6 | 0.5 | 2.5 | 1.2 | 2.3 | 0.4 | 2.6 | 0.2 |
| 170° C. @ | | | | | | | | | | |
| 10 bar | | | | | | | | | | |
| 12 s @ | 2.9 | 0.8 | 3.4 | 0.1 | 3.8 | 0.5 | 3.3 | 0.2 | 3.5 | 0.3 |
| 180° C. @ | | | | | | | | | | |
| 10 bar | | | | | | | | | | |
| 10 s @ | 3.4 | 0.7 | 3.5 | 0.7 | 2.9 | 0.4 | 3.1 | 0 | 3.2 | 0.3 |
| 190° C. @ | | | | | | | | | | |
| 10 bar | | | | | | | | | | |

w = weeks,
s = standard deviation

### Push-Out Test after Storage (Comparative Example 7)

| | | | 17 d | | 38 d | | 13 w | |
|---|---|---|---|---|---|---|---|---|
| Pressing | fresh | | 40° C. | | 40° C. | | 40° C. | |
| conditions | MPa | s | MPa | s | MPa | s | MPa | s |
| 30 s @ | 5.6 | 0.2 | 3.2 | 0.6 | 2.2 | 0.1 | 1.6 | 0.2 |
| 170° C. @ | | | | | | | | |
| 10 bar | | | | | | | | |
| 10 s @ | 5.6 | 0.6 | 2.7 | 0.1 | 1.8 | 0.2 | 1.1 | 0.1 |
| 190° C. @ | | | | | | | | |
| 10 bar | | | | | | | | |

w = weeks,
d = days,
s = standard deviation

### Heat-and-Humidity Resistance after Storage (Comparative Example 7)

| | | | 17 d | | 38 d | | 13 w | |
|---|---|---|---|---|---|---|---|---|
| Pressing | fresh | | 40° C. | | 40° C. | | 40° C. | |
| conditions | MPa | s | MPa | s | MPa | s | MPa | s |
| 30 s @ | 7 | 0.2 | 1.6 | 0.3 | 2.4 | 0.4 | 1.4 | 0.3 |
| 170° C. @ | | | | | | | | |
| 10 bar | | | | | | | | |
| 10 s @ | 6.8 | 0.1 | 2.6 | 0.2 | 1.8 | 0.4 | 1.3 | 0.5 |
| 190° C. @ | | | | | | | | |
| 10 bar | | | | | | | | |

w = weeks,
d = days,
s = standard deviation

DSC Measurements

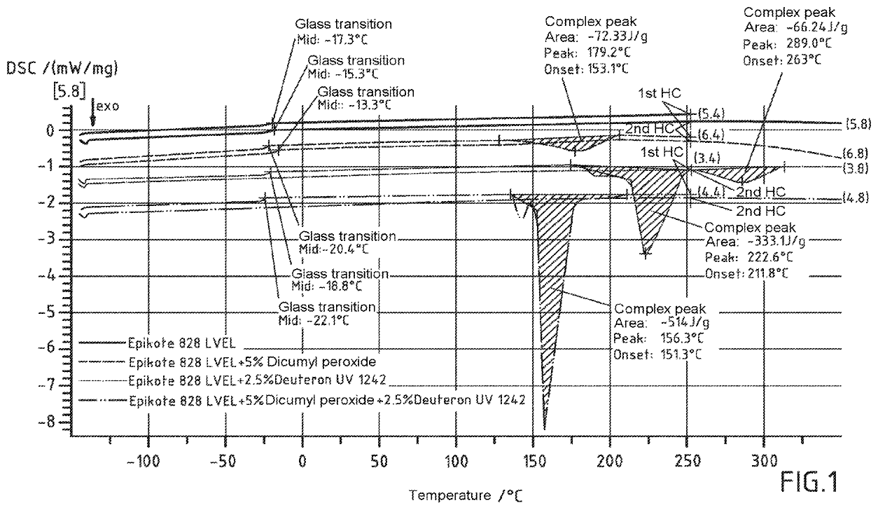

With the inventive and comparative examples, DSC measurements were conducted in order to investigate the effect of the components on the crosslinking behavior (i.e., the curing of the adhesive film). The results are shown in FIGS. 1 to 3.

DSC Measurement:

Instrument: DSC 204 F1 Phoenix, from Netzsch

Crucible: Al crucible, lid perforated manually

Temperature program: 20° C.→−140° C.; −140° C.→250° C. (first heating curve)
(optional) 250° C.→−140° C.; −140° C.→350° C. (second heating curve)

Temperature rate: 10 K/min (cooled with liquid N2)

Method/SOP: DSC-01

FIG. 1 shows the results of the epoxy resin investigated, with Comparative examples 1 to 3 and Inventive example 1.

In a second heating curve carried out, no after-crosslinking can be observed for Inventive example 1, in contrast to Comparative example 2.

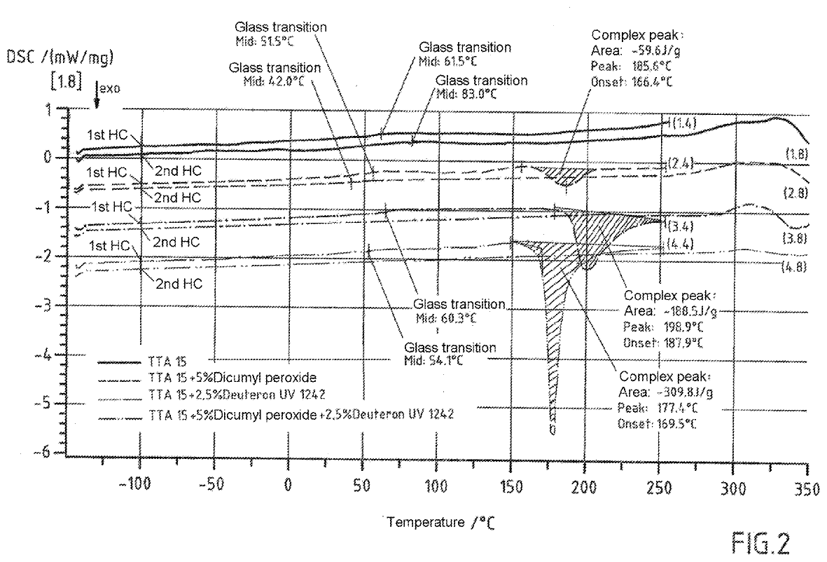

FIG. 2 shows the results of the epoxide homopolymer investigated, with Comparative examples 4 to 6 and Inventive example 2.

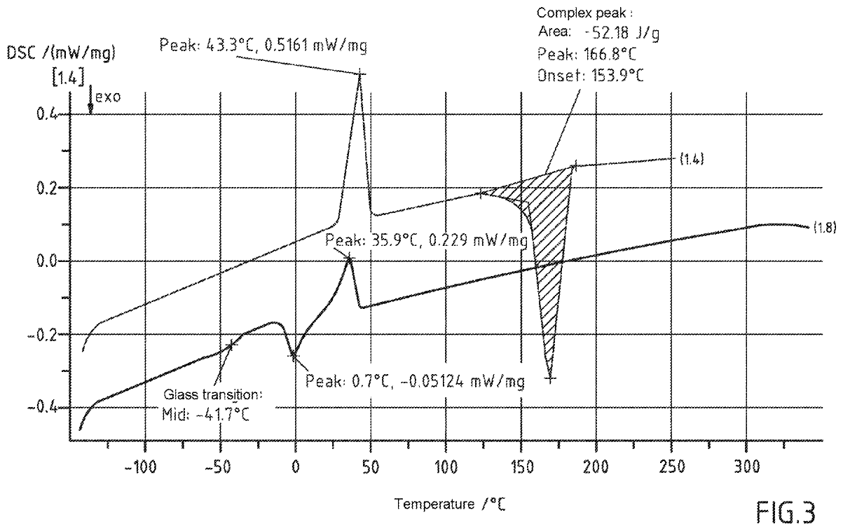

FIG. 3 shows the results of the latent reactive adhesive film investigated, with Inventive example 3.

The designation of the curves in the figures is in line with the example numbers. The symbols “+” symbolize the positions of the values as reported in the two tables below.

Values in FIG. 1:

| | | Enthalpy | Enthalpy |
|---|---|---|---|
| | Enthalpy | onset | maximum |
| Example | [J/g] | [° C.] | [° C.] |
| Comparative | / | / | / |
| example 1 | | | |
| Comparative | 333 (1st HC)/ | 212 (1st HC)/ | 223 (1st HC)/ |
| example 2 | 66 (2nd HC) | 263 (2nd HC) | 289 (2nd HC) |
| Comparative | 72 | 153 | 179 |
| example 3 | | | |
| Inventive | 514 | 151 | 156 |
| example 1 | | | |

HC = heating curve

Values in FIG. 2:

| | | Enthalpy | Enthalpy |
|---|---|---|---|
| | Enthalpy | onset | maximum |
| Example | [J/g] | [° C.] | [° C.] |
| Comparative | / | / | / |
| example 4 | | | |
| Comparative | 189 | 188 | 199 |
| example 5 | | | |
| Comparative | 60 | 166 | 186 |
| example 6 | | | |
| Inventive | 310 | 170 | 177 |
| example 2 | | | |

Values in FIG. 3:

| | | Enthalpy | Enthalpy |
|---|---|---|---|
| | Enthalpy | onset | maximum |
| Example | [J/g] | [° C.] | [° C.] |
| Inventive | 52 | 154 | 167 |
| example 3 | | | |

In the DSC it is clearly apparent that the inventive examples exhibit an earlier (enthalpy maximum [° C.]) and significantly more defined (harder) reactivity (enthalpy [J/g]) than the reference specimens (comparative examples) with the individual components. Moreover, the reaction enthalpy (enthalpy [J/g]) of the inventive examples is significantly higher than the added reaction enthalpies of the respective individual components (comparative examples), providing evidence of a more complete curing reaction. Furthermore, the T_{G} ‘disappears’ after the curing reaction from the inventive examples with the respective epoxides (epoxy resin, epoxide homopolymer) outside the measuring range, the epoxy resin and the epoxide homopolymer becoming thermosets.

1. A thermally curable adhesive film comprising at least one layer of an adhesive which comprises
at least one (co)polymer (A) functionalized with epoxide groups and having a weight-average molar mass in the range from 5 000 g/mol to 5 000 000 g/mol and/or at least one epoxide-containing compound (B) which is different from the (co)polymer (A);
at least one radical initiator (C);
at least one photo acid generator (D);
optionally at least one matrix polymer as film former (E); and
optionally at least one additive (F).

2. The adhesive film as claimed in claim 1,
which comprises at least one (co)polymer (A) functionalized with aliphatic epoxide groups and having a weight-average molar mass in the range from 5 000 g/mol to 500 000 g/mol,
and/or
the weight-average molar mass of the (co)polymer (A) is at least 10 000 g/mol;
and/or
the weight-average molar mass of the (co)polymer (A) is at most 2 000 000 g/mol;
and/or
the (co)polymer (A) is functionalized using cycloaliphatic epoxides, more particularly 3,4-epoxycyclohexyl-substituted monomers;
and/or
the at least one (co)polymer (A) has more than 5 to 100 wt %, based on the entirety of the monomers on which the (co)polymer (A) is based, of at least one kind of a (meth)acrylic (co)monomer (a) functionalized with a cycloaliphatic epoxide.

3. The adhesive film as claimed in claim 1,
which comprises
at least one (co)polymer (B1) containing glycidyl ether groups, where
the at least one (co)polymer (B1) is comprised with a weight-average molar mass in the range from 5 000 g/mol to 500 000 g/mol;
and/or
the weight-average molar mass of the (co)polymer (B1) is at least 10 000 g/mol;
and/or
the weight-average molar mass of the (co)polymer (B1) is at most 2 000 000 g/mol.

4. The adhesive film as claimed in claim 1, wherein the at least one radical initiator (C) comprises at least two organyl groups and/or
the at least one radical initiator (C) is a peroxide and/or
the peroxide (C1) used is dicumyl peroxide.

5. The adhesive film as claimed in claim 1, wherein
the amount of radical initiator (C) in the adhesive is selected in the range from 0.1 to 10 wt %.

6. The adhesive film as claimed in claim 1, wherein
the at least one matrix polymer (E) is a thermoplastic polymer;
and/or
in that the at least one matrix polymer (E) is a polyurethane;
and/or
in that the matrix polymers (E) have maximum softening temperatures and/or decrystallization temperatures, measured by means of DSC, of at most 25° C.;
and/or
in that the matrix polymers (E) have a maximum glass transition temperature, measured by means of DSC, of not more than −25° C.

7. The adhesive film as claimed in claim 1, wherein
the at least one (co)polymer (A) and/or the at least one epoxide-containing compound (B) are/is comprised in the adhesive at 5 to 99.8 wt %;
and/or
the at least one radical initiator (C) is comprised at 0.1 to 10.0 wt %;
and/or
the at least one photo acid generator (D) is comprised at 0.1 to 10.0 wt %;
and/or
the at least one matrix polymer (E) is comprised at 2.0 to 94.5 wt %;
and/or
at least one additive (F) is comprised at 0.1 to 50 wt %
where the wt % figures are based in each case on the total weight of the adhesive.

8. The adhesive film as claimed in claim 1, wherein the adhesive comprises substantially no thermal acid generator (TAG).

9. The adhesive film as claimed in claim 1, wherein the layer of adhesive has a layer thickness of less than 500 μm.

10. The adhesive film as claimed in claim 1, wherein the thermal curing, determined by the enthalpy measured by means of DSC, takes place only at 120 to 250° C.

11. An assembly comprising two substrates which are bonded by an adhesive film as claimed in claim 1.

12. A method for joining two substrates using an adhesive film as claimed in claim 1.

13. The method as claimed in claim 12, where the substrates very largely absorb light in the UV range or are opaque to light and/or UV.
